(19) United States
(12) Patent Application Publication
(10) Pub. No.: US 2026/0236999 A1
(43) Pub. Date: Aug. 13, 2026

(54) SYSTEMS AND METHODS THAT IMPLEMENT HEALTHCARE CLAIMS ANALYSIS FOR RETURNING A CONSENSUS RESPONSE TO NATURAL LANGUAGE INPUT

(71) Applicant: UNIVERSITY OF MARYLAND, BALTIMORE COUNTY, BALTIMORE, MD (US)

(72) Inventors: James Clavin, Baltimore, MD (US); Karuna Joshi, Baltimore, MD (US)

(21) Appl. No.: 19/533,126

(22) Filed: Feb. 7, 2026

Related U.S. Application Data
(60) Provisional application No. 63/756,508, filed on Feb. 10, 2025.

(51) Int. Cl. G06Q 40/08

(52) U.S. Cl. CPC G06Q 40/084

(57) ABSTRACT

Systems and methods that implement healthcare claims analysis for returning a consensus response to natural language input are disclosed. According to an aspect, a system having a knowledge graph store configured to store a claims knowledge graph having nodes that represent healthcare claims. The knowledge graph store is also configured to store a regulated-content knowledge graph having nodes that represent healthcare codes. The nodes that represent healthcare claims in the claims knowledge graph are linked to nodes that represent healthcare codes. Each computing device node includes a graph query and response manager that receives a natural language input, and executes a graph query against the claims knowledge graph and the sensitivity knowledge graph for generating a proposed natural language response that describes one or more healthcare claims. The system includes a consensus module configured to receive the proposed natural language responses from the computing device nodes.

### CROSS-REFERENCE TO RELATED APPLICATION

This application claims priority to U.S. Provisional Patent Application No. 63/756,508, filed Feb. 10, 2025, and titled MEDICAL DATA POLYGRAPH, the content of which is incorporated herein by reference in its entirety.

### BACKGROUND

Artificial Intelligence (AI) is being used by claims processors to both deny more claims for patients and to capture revenue from government payers by adjusting claims to have higher billed diagnoses. On the one hand, the number of claims denied by healthcare insurers has risen remarkably since the 1990s. On the other hand, it has been observed that the Centers for Medicare and Medicaid Services (CMS) paid $1.3 trillion in claims in 2022, of which overpayments formed 8% or $100 billion. For the CMS public-private Medicare Advantage program, researchers have found that insurers such as UnitedHealth used AI to identify claims that may be recategorized into a higher billed category, then worked to change the diagnosis accordingly. This is often accomplished with both the provider and the patient completely unaware and resulted in overpayments of $50B to provide insurers by taxpayers over a five-year time span. These AI solutions are “black boxes” and can cause denials of medically necessary treatment, creating stressful situations, and possible outcomes for patients.

Claims AI is used by organizations referred to as “clearinghouses,” which reside between payers and providers. This third entity was created by the Health Insurance Portability and Accountability Act (HIPAA) and is dedicated to converting clinical data into a billable format referred to as a claim and adjudicating (paying/denying) the claim, as depicted in FIG. 1. FIG. 1 illustrates a flow diagram that depicts electronic data interchange (EDI) flow. The “837” is the standard claim format. The “835” is the standard payment/denial adjudication response. Further, from left to right in FIG. 1 shows the clinical data being converted into billable format and paid to provider.

Clearinghouses dedicated to handling clinical and claims data are vulnerable to cyberattacks and can hobble the financial flow of healthcare payments on a national scale. The Change clearinghouse (a subsidiary of UnitedHealth) cyberattack in early 2024 affected 100 million people and cost approximately $1 billion. In 2024, a clearinghouse handling CMS data fell victim to the MOVEIt secure file transfer breach, resulting in millions of Medicare beneficiaries' personal information being compromised.

In view of the foregoing, there is a need to provide a secure claims adjudication system that functions as a clearinghouse dedicated to providing transparency while automating the reconciliation of financial records between payers and payments received. It is desired to provide systems having security mechanisms that ensure the system remains reliable and continues to operate correctly even in the presence of faults and malicious activity.

### SUMMARY OF THE DISCLOSURE

The presently disclosed subject matter includes systems and methods that implement healthcare claims analysis for returning a consensus response to natural language input. According to an aspect, a system having a knowledge graph store configured to store a claims knowledge graph having nodes that represent healthcare claims. The knowledge graph store is also configured to store a regulated-content knowledge graph having nodes that represent healthcare codes. The nodes that represent healthcare claims in the claims knowledge graph are linked to nodes that represent healthcare codes of the sensitivity knowledge graph. The computing device nodes are configured to implement a consensus protocol among each other. Each computing device node includes a graph query and response manager configured to receive a natural language input, generate a graph query based on the natural language input, and execute the graph query against the claims knowledge graph and the sensitivity knowledge graph for generating a proposed natural language response that describes one or more healthcare claims. The system also includes a consensus module configured to receive the proposed natural language responses from two or more of the computing device nodes. The consensus module is also configured to apply a consensus protocol to the received, proposed natural language responses to generate a consensus natural language response among the two or more of the computing device nodes. Further the system includes a user interface configured to receive the natural language input from a user, and configured to present the consensus response.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a block diagram of a system for implementing healthcare claims analysis and consensus functionalities in accordance with embodiments disclosed herein;

FIG. 2 is a flow diagram of a method for implementing healthcare claims analysis and consensus functionalities in accordance with embodiments disclosed herein;

FIG. 3 is a depiction of an example framework using AI and blockchain technologies in accordance with embodiments of the present disclosure;

FIG. 4 depicts a diagram of architecture and interaction flow of an example system in accordance with embodiments of the present disclosure;

FIG. 5 illustrates a diagram of the CMS Medicare claim process, wherein providers submit claims, which undergo validation, and receive payments for accepted claims via electronic funds transfer;

FIG. 6 illustrates a diagram depicting operation for a permissioned blockchain running a BFT protocol Practical Byzantine Fault Tolerance (PBFT), where control messages refer to message for nodes to reach a consensus;

FIG. 7 illustrates a visual representation of this a system with n computing nodes;

FIG. 8 illustrates a diagram of a framework for evaluating BFT protocols;

FIG. 9 is a diagram of the communication process, with 4 servers (referred to as replicas) running BFT-SMaRt, each with a Python shim;

FIG. 10 illustrates a diagram of a main interface having three components: user configuration, visualization, and system log;

FIG. 11 illustrates a diagram of a ByzGame system model;

FIG. 12 depicts graphs showing the percentage of subject teams who answer the questions correctly before and after showing ByzGame;

FIG. 13 is a table showing that human reviews achieve higher performance than ML in accuracy and precision;

FIG. 14 shows codes of remix connected to localhost;

FIG. 15 provides an example of code for loading claims data in ttl format into a graph, then creating a chat object using Ollama running the codellama model;

FIG. 16 illustrates a diagram of core components of a system in accordance with embodiments;

FIG. 17 illustrates a diagram showing API and various features;

FIG. 18 illustrates a table that contains an excerpt from the Part A (hospital) header file definition;

FIG. 19 depicts a listing of Part 2 clinical terms by category;

FIG. 20 is a diagram depicting modeling of ad hoc claims data in a graph format, where one patient has six claims;

FIG. 21 illustrates a diagram of an example of an 837 claim file as modeled in a graph database;

FIG. 22 is a diagram with the claim identifier at the center, and the claim attributes displayed on the right;

FIG. 23 is a diagram of a Part 2 knowledge graph;

FIG. 24 is a diagram that demonstrates the graph populated with LOINC and SNOMED-CT terms for a Lab of Opioids and a Diagnosis of Mental Health Disorder;

FIG. 25 illustrates a diagram of a Part 2 SNOMED-CT code linked to a claim;

FIG. 26 depicts that claims that have the relationship “CONTAINS_PART_2” to “Mental Health Disorders”;

FIG. 27 is a diagram depicting sleep disorder ad hoc claim attributes;

FIG. 28 shows code for a SPARQL query to detect Part 2 data in ad hoc claims data;

FIG. 29 shows code for a cypher query to aggregate Part 2 data in ad hoc claims data;

FIG. 30 shows code for a query that gets all Part 2 procedures from an EDI claims data set stored in a Neo4j graph database;

FIG. 31 shows the results of the query of FIG. 30;

FIG. 32 illustrates a diagram of batch system architecture;

FIG. 33 illustrates a diagram of batch mode components;

FIG. 34 illustrates software code for using remix to edit a smart contract as disclosed herein;

FIG. 35 is a screen display of an example batch user interface;

FIG. 36 depicts transaction details that show the files that had a Part 2 compliance issue;

FIG. 37 illustrates a diagram of system shims in accordance with embodiments of the present disclosure;

FIG. 38 illustrates a screen display that shows the system chat, with a question about which claims contain Part 2 procedure codes;

FIG. 39 illustrates a screen display showing a user interface call to the server;

FIG. 40 illustrates a diagram with data generators and shows the ad hoc claims data being generated by Synthea, then loaded into a knowledge graph;

FIG. 41 illustrates a user interface including the application's main screen;

FIG. 42 illustrates a user interface including data generation options;

FIG. 43 illustrates a user interface for EDI data generation options;

FIG. 44 shows an excerpt of the code, demonstrating connecting to Gemini and prompting it to generate EDI data;

FIG. 45 shows a user interface with ad hoc data generation options;

FIG. 46 shows a table containing example claims data;

FIG. 47 illustrates example error log containing issues with data elements;

FIG. 48 illustrates Python code to regenerate EDI claims data using X12 validation in context;

FIG. 49 illustrates a user interface showing a MetaMask and reflects its ability to connect to MainNet, local testnets, and public test networks;

FIG. 50 shows the servers starting and preparing to take client requests;

FIG. 51 shows the Electron-based application with the human prompt on the left, and the server response on the right;

FIG. 52 is a diagram that displays a specific type of Ethereum node, in this case ‘geth’, which is the Go version of Ethereum;

FIG. 53 illustrates a Kurtosis TEFCA network overview;

FIG. 54 illustrates a system batch mode-Blockscout post-merge;

FIG. 55 is a table that shows the distribution of this sample according to our knowledge graph's attributes of value set name-either diagnosis or finding in this case as we have no lab data;

FIG. 56 is a table captures the performance and cost metrics;

FIG. 57A and FIG. 57B show displays a log excerpt from one of the polygraph servers; and

FIG. 58 is a table that shows quantitative benchmarks.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a “user interface” is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a GUI that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

As used herein, the term “memory” is generally a storage device of a computing device. Examples include, but are not limited to, read-only memory (ROM) and random access memory (RAM).

Healthcare payments are adjudicated by intermediaries called clearinghouses, which reside between healthcare providers and payers. The increasing use of AI in claims processing by clearinghouse has spiked denials, frustrating patients who often lack insight into the reasons for denials. This opacity contributes to rising healthcare costs, patient data, and disrupting the national claims process.

In accordance with embodiments, disclosed herein are medical data polygraph (MDP), an AI, and blockchain-based secure systems that can be utilized as a clearinghouse. Methods are also disclosed herein for implementing these functionalities. These systems and methods can translate standard claims data into intuitive, accessible formats for enabling stakeholders to ask plain-language questions such as “Why was my claim denied?” or “Reconcile claims against our ledge for the past month.” Further, these systems and methods can support contextual follow-ups such as “How do I appeal this denial?” or “Show the Medicaid patient claims ledger.”

As referred to herein, a “knowledge graph” is a computer-implemented, graph-structured knowledge base that represents information as a set of entities and typed relationships between those entities. A knowledge graph store may store one or more knowledge graphs. The information of a knowledge graph may be stored as nodes that represent entities. Example entities include, but are not limited to, objects, concepts, persons, places, components, processes, data assets, events, or other real world or abstract items of interest. Further, the information may be stored as edges that represent semantic relations between the entities. Edges can represent relationships (or relations) between pairs of entities, the relationships being directed or undirected and optionally labeled to indicate the semantic nature of the association (e.g., “is-a”, “part-of”, “causes”, “located-in”, “related-to”, or domain-specific relations). The nodes and edges may have associated attributes, such that the resulting graph encodes machine-readable facts that can be queried, analyzed, and used to derive additional implicit knowledge by automated reasoning or learning techniques. In some implementations, a knowledge graph may conform to a predefined ontology or schema that defines entity types (classes), relationship types, attributes/properties of entities, and constraints thereon, thereby providing a consistent semantic framework for the represented domain.

As referred to herein, a “consensus protocol” is a computer-implemented coordination procedure implemented by distributed computing device nodes, which, via exchange of messages according to predetermined rules, causes all non-faulty nodes to reach agreement on a common value or ordered sequence of values. As a result, a consistent system state can be provided despite differences in initial inputs and the presence of node or communication failures, including in some implementations arbitrary or faults. An example consensus protocol includes, but is not limited to, a Byzantine Fault Tolerant consensus protocol.

As referred to herein, the term “natural language” to any language that can be understood by humans. Examples include, but are not limited to English, Spanish, etc. In examples, computing devices and computing systems can handle natural language by turning text into numbers, running the text through trained models, and then turning the result back into natural language. Main steps include preprocessing and tokenization, embedding into vectors, model interpretation, and producing an output.

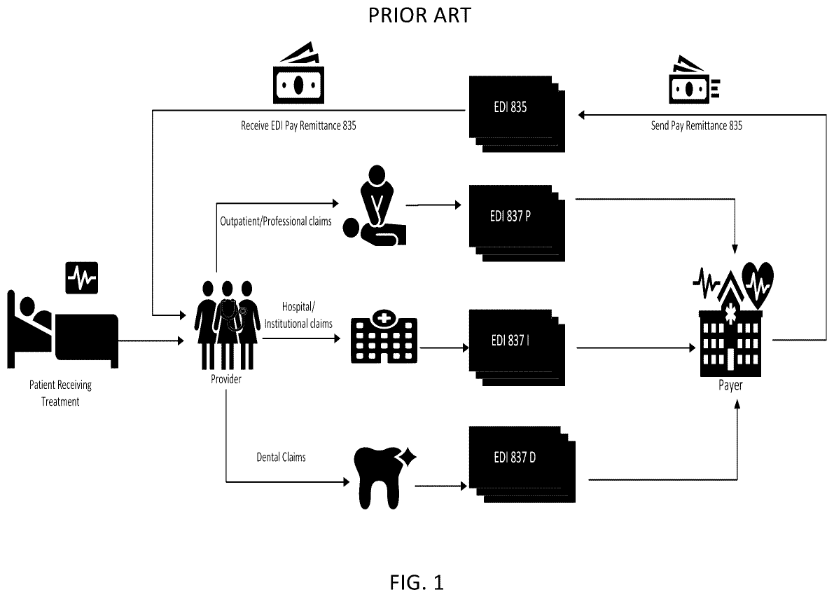

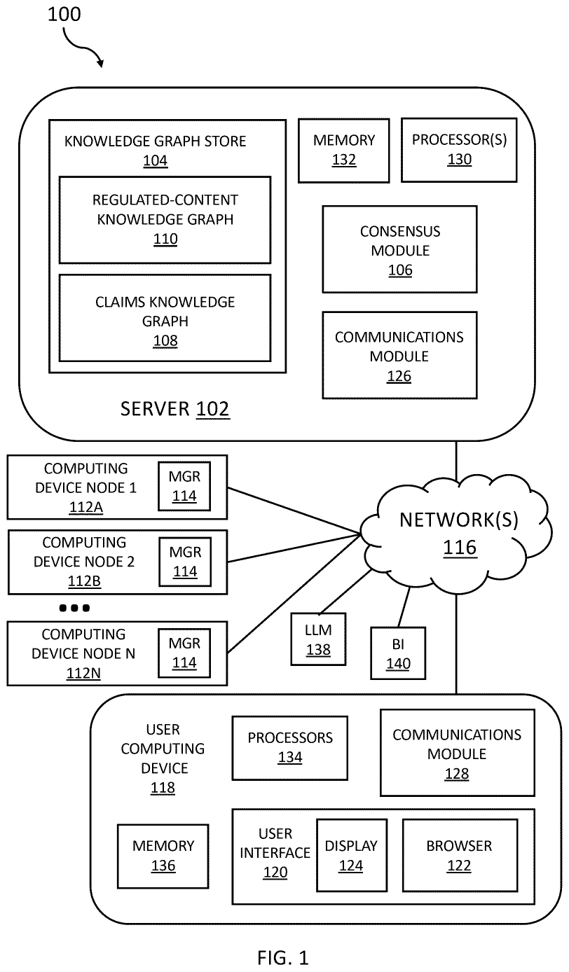

FIG. 1 illustrates a block diagram of a system 100 for implementing healthcare claims analysis and consensus functionalities in accordance with embodiments disclosed herein. Referring to FIG. 1, the system 100 includes a server 102 having a knowledge graph store 104 and a consensus module 106. The knowledge graph store 104 is configured to store a claims knowledge graph 108 and a regulated-content knowledge graph 110. The claims knowledge graph 108 has nodes that represent healthcare claims. The regulated-content knowledge graph 110 has nodes that represent clinical codes associated with sensitive or regulated content. In some examples, nodes that represent healthcare claims in the claims knowledge graph 108 are linked to nodes that represent clinical codes in the regulated-content knowledge graph 110 to indicate that the corresponding claims include those clinical codes.

The consensus module 106 is operatively coupled to computing device nodes 1-N 112A-112N. The letter “N” indicates that there can be any suitable number of computing device nodes 112A-112N. Each computing device node 112A-112N can include a graph query and response manager 114 configured to receive natural language prompts or inputs. Each graph query and response manager 114 can also generate graph queries over the claims knowledge graph 108 and the regulated-content knowledge graph 110. Further, each graph query and response manager 114 can and produce proposed natural-language responses describing one or more healthcare claims. The computing device nodes 112A-112N can be communicatively connected to server 102 via one or more networks 116. The consensus module 106 is configured to receive the proposed natural-language responses from two or more of the computing device nodes 112A-112N and to apply a consensus protocol, such as a Byzantine Fault Tolerant consensus protocol, to select a consensus natural language response.

The system 100 can include one or more computing devices that are each configured to access server 102 for sending natural language inputs and for presenting consensus responses to the natural language inputs. For example, a computing device 118 can be utilized in accordance with embodiments disclosed herein for sending natural language inputs and for presenting consensus responses to the natural language inputs. The user computing device 118 includes a user interface 120 through which its user, such as a claims reviewer or analyst, can input natural language prompts or inputs, and can receive consensus natural language responses. In embodiments, the user interface 120 can be implemented as a chat-style interface that allows the user to iteratively explore the claims knowledge graph 108 and the regulated-content knowledge graph 110. In example, the user interface may include a browser 122 with which the user can enter inputs (e.g., natural language prompts) and be presented with responses (e.g., natural language responses). The user interface 120 includes a display 124 that may present natural language responses or other related information such that the user can interact with the server 102 for sending natural language inputs and for presenting consensus responses to the natural language inputs.

The server 102, the computing device nodes 112A-112N, and the user computing device 118 are communicatively coupled via the network(s) 116, which may include one or more of a local area network (LAN), a wide area network (WAN), a cellular network, the Internet, and/or the like. In operation, the user computing device 118 can transmit a natural language prompt or input over the network(s) 116 to the computing device nodes 112A-112N. The computing device nodes 112A-112N can each receive the natural language input via the network(s) 116. Further, the computing device nodes 112A-112N can each generate a proposed natural language response based on queries against the knowledge graph store 104. The consensus module 106 can determine a consensus natural language response that is returned over the network(s) 116 for presentation (e.g., display via the display 122) to the user at the user interface 120. The server 102 can include a communications module 126 configured to facilitate communication via the network(s) 116. Further, the user computing device 118 can include a communications module 128 configured to facilitate communication via the network(s) 116.

Functionalities of each of the server 102, user computing device 118 (or other user computing devices), and computing device nodes 112A-112N may be implemented by suitable hardware, software, and/or firmware. For example, functionalities of the server 102 may be implemented by one or more processors 130 that implement instructions stored in memory 132. Further, for example, functionalities of the user computing device 118 may be implemented by one or more processors 134 that implement instructions stored in memory 136. Each computing device 112A-112N can be a server configured for communication with the server 102 and the user computing device 118 via the network(s) 116.

In some embodiments, the system 100 further includes or is operatively coupled to a large language model (LLM) 138. The LLM 138 can be executed by one or more of the computing device nodes 112A-112N, by the server 102, and/or other servers (not shown). The LLM 138 can be configured to transform a natural language input received via the user interface 120 into a graph query based on a schema of the claims knowledge graph 108 and the regulated-content knowledge graph 110. For example, a graph query and response manager 114 of a given computing device node 112A-112N can provide, as context to the LLM 138, information describing node types, relationships, and properties of the claims knowledge graph 108 and the regulated-content knowledge graph 110, such that the LLM 138 generates a syntactically correct query in a selected graph query language.

In certain implementations, each computing device node 112A-112N can use a graph schema technique to generate a graph query. For example, a graph query and response manager 114 can obtain a schema or ontology describing classes and relationships of the claims knowledge graph 108 and the regulated-content knowledge graph 110, and can supply that schema to the LLM 138 or another query generator component as structured context. The graph query and response manager 114 can then validate syntax of the generated graph query prior to executing the query against the claims knowledge graph 108 and the regulated-content knowledge graph 110, for example by parsing the query or by utilizing a validation capability of an underlying graph database engine.

In embodiments, the consensus module 106 can implement a Byzantine Fault Tolerant consensus protocol or another consensus protocol. The consensus module 106 can receive proposed natural language responses from the computing device nodes 112A-112N and to determine whether at least a quorum of the computing device nodes 112A-112N have produced matching or equivalent proposed natural-language responses, in accordance with the Byzantine Fault Tolerant consensus protocol or another suitable consensus protocol. The consensus module 106 can select, as the consensus natural language response, a proposed natural language response that is agreed upon by at least the quorum.

The regulated-content knowledge graph 110 can be constructed from value sets provided by one or more governmental or regulatory bodies that designate clinical codes associated with substance use disorder or mental health treatment. For example, the regulated-content knowledge graph 110 can be built from value sets that identify clinical codes corresponding to substance abuse and mental health concepts and may encompass codes from multiple clinical terminologies. In embodiments, the healthcare codes represented in the regulated-content knowledge graph 110 can be clinical codes and can be associated with sensitive content, such as substance use disorder diagnoses, mental health diagnoses, or related laboratory and procedure codes, and may be subject to confidentiality restrictions and/or data-use restrictions.

In embodiments, the system 100 further includes a blockchain interface 140 operatively coupled to the server 102. The blockchain interface 140 can be configured to submit, to a blockchain network, transactions including metadata describing healthcare claims identified by a given graph query as including healthcare codes represented in the regulated-content knowledge graph 110. The metadata can further include a measure of computational resources expended in executing the graph query, such as an execution duration, a number of compute operations, or a gas cost converted into a currency value. The blockchain network can record such transactions in an immutable ledger, thereby providing an auditable record of detection of regulated content within exchanged claims data.

The user interface 120 can be present, together with the consensus natural-language response, additional details regarding the underlying claims and graph relationships. For example, the user interface 120 can present an identifier of each healthcare claim referenced in the consensus response, such as a claim identifier or control number, and/or a visualization of relationships between the healthcare claims and corresponding clinical codes in the regulated-content knowledge graph 110. In some embodiments, the user interface 120 can allow the user to select a particular healthcare claim referenced in the consensus response. In response to receiving such a user selection, the user interface 120 can present underlying claim attributes retrieved from the claims knowledge graph 108, such as patient identifiers, provider identifiers, dates of service, diagnosis codes, procedure codes, amounts billed or paid, and/or the like.

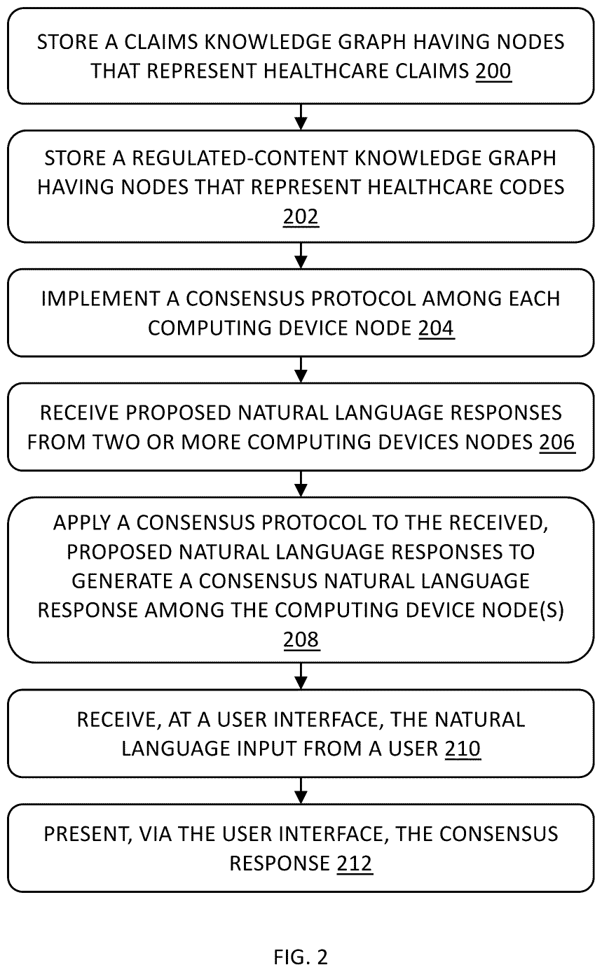

FIG. 2 illustrates a flow diagram of a method for implementing healthcare claims analysis and consensus functionalities in accordance with embodiments disclosed herein. It is noted that the method is described by example as being implemented by the system shown in FIG. 1. Although, it should be understood that the method may alternatively be implemented by any other suitable system.

Referring to FIG. 2, the method includes storing 200 a claims knowledge graph having nodes that represent healthcare claims. Continuing the aforementioned example, the claims knowledge graph 108 can represent healthcare claims in a semantic, node-and-edge structure that exposes the relationships among claim elements for analysis and querying in accordance with embodiments of the present disclosure. Each claim in a claims data set can be modeled as a claim node that is connected to nodes representing its key attributes, such as patient identifiers, provider identifiers, diagnoses, procedures, service lines, dates, financial amounts, or the like. For some claims data, the graph can include nodes for patients, encounters, and individual claims, with relationships capturing which claims belong to which patient, and edges from each claim node to diagnosis and procedure code nodes, dates of service, and cost or payment amounts. For Electronic Data Interchange (EDI) 837 claims, the graph can mirror the hierarchical loop/segment structure of the X12 format, for example by connecting each claim node to nodes representing loops, segments, and data elements such as principal diagnosis, revenue codes, and release-of-information codes. In embodiments, the claims knowledge graph can be designed to be compatible with multiple clinical coding systems and external ontologies. Diagnosis and procedure attributes of a claim node can be linked to code nodes (e.g., ICD diagnosis codes or HCPCS procedure codes) that may also appear in external regulated-content graphs, enabling cross-graph linking. In this way, the claims knowledge graph serves as the internal representation of claim-centric data, while also acting as the anchor for relationships to external knowledge graphs such as substance-use and mental-health code graphs. This structure allows graph queries to efficiently identify all claims that share particular clinical characteristics, providers, or patterns of utilization, and to support natural-language exploration via GraphRAG-based query generation.

The method of FIG. 2 includes storing 202 a regulated-content knowledge graph having nodes that represent healthcare codes. Continuing the aforementioned example, the nodes that represent healthcare claims in the claims knowledge graph can be linked to nodes that represent healthcare codes of the sensitivity knowledge graph. The regulated-content knowledge graph 110 can represent a set of clinical codes that are treated as sensitive or regulated, together with their categorizations and relationships, in a machine-interpretable graph form. In embodiment, the regulated-content knowledge graph can be built from value sets published by governmental or regulatory bodies, such as SAMHSA/NIH value sets, that enumerate codes associated with substance use disorder and mental health treatment across multiple terminologies (ICD-9/10, SNOMED-CT, LOINC, CPT, HCPCS, RxNorm, etc.). Each node in the graph can correspond to a clinical code or otherwise regulated, and nodes are linked to category nodes (e.g., “Opioids,” “Mental Health Disorders,” “Other Psychoactive Substance Use Disorders”) via relationships that capture how the value sets classify those codes. The regulated-content knowledge graph is designed to be linkable to the claims knowledge graph via shared code identifiers. When a claim in the claims knowledge graph includes a diagnosis, procedure, or lab code that appears in the regulated-content knowledge graph, the claim node is connected to the corresponding regulated-content node, thereby marking that claim as containing regulated content. This linkage allows graph queries to retrieve all claims involving sensitive clinical concepts, to aggregate them by value-set category, and to support natural-language questions such as “which claims contain opioid lab codes or mental health disorder diagnoses?” through GraphRAG-generated queries.

The method of FIG. 2 includes implementing 204 a consensus protocol among each computing device node. Continuing the aforementioned example, each computing device node 112A-112N includes a graph query and response manager 114 that can receive a natural language input, generate a graph query based on the natural language input, and execute the graph query against the claims knowledge graph and the sensitivity knowledge graph for generating a proposed natural language response that describes one or more healthcare claims.

The method of FIG. 2 includes receiving 206 the proposed natural language responses from two or more of the computing device nodes. Continuing the aforementioned example, in operation, the consensus module 106 can receive proposed natural-language responses that have been generated independently by two or more of the computing device nodes 112A-112N in response to the same natural-language input. Each computing device node 112A-112N can transmit its proposed response over the network(s) 116, and the consensus module 106 can collect these responses, associate them with the originating computing device nodes 112A-112N and the corresponding input prompt, and prepares them for evaluation under the consensus protocol.

The method of FIG. 2 includes applying 208 a consensus protocol to the received, proposed natural language responses to generate a consensus natural language response among the two or more of the computing device nodes. Continuing the aforementioned example, a consensus protocol implemented by the consensus module 106 can coordinate multiple computing device nodes 112A-112N so they collectively agree on a single answer or response to a user's query before returning it. Each computing device node 112A-112N independently generates a graph query and a proposed natural-language response based on the claims and regulated-content knowledge graphs, then broadcasts its proposal to the other nodes. The consensus protocol—implemented as a Byzantine Fault Tolerant scheme—compares the proposed responses and selects a consensus response that is supported by at least a quorum of nodes, allowing the system to tolerate faulty or inconsistent nodes while still producing a single trusted answer.

The method of FIG. 2 includes receiving 210, at a user interface, the natural language input from a user. Continuing the aforementioned example, at the outset of an interaction, the system 100 can receive, at the user interface 120, a natural language input from a user such as a claims reviewer or analyst. The user interface 120, for example a chat-style graphical interface running on a user computing device, can provide an input field in which the user types or speaks a question or instruction regarding healthcare claims, and the interface 120 can capture this natural language input and forwards it over the network(s) 116 to the server 102 and computing device nodes 112A-112N for processing.

The method of FIG. 2 includes presenting, via the user interface, 212 the consensus response. Continuing the aforementioned example, subsequent to the consensus module 106 selecting a consensus natural-language response, the user interface 120 can present the consensus response to the user via the user interface 120. The user interface 120, such as the chat-style display on the user computing device, renders the consensus response as human-readable text (and optionally accompanying identifiers or visualizations) so that the user can review the agreed-upon explanation or results derived from the underlying claims and regulated-content knowledge graphs.

In accordance with embodiments, a system is disclosed herein that utilizes AI and blockchain technologies for securely exploring claims data and for measuring the cost of out-of-compliance data exchange. In embodiments as disclosed herein, systems are an integration of Byzantine Fault Tolerant (BFT) consensus protocols with Graph-based Generative AI Retrieval Augmented Generation (RAG) technology. Although use of BFT consensus protocols and RAG technology as described as implementing example systems and methods disclosed herein, it should be understood that alternative consensus protocols and AI technologies may be utilized. The framework of use of BFT consensus protocols with RAG technology can uphold distributed system security by leveraging two-layer consensus mechanisms and enforcing BFT consensus on RAG-augmented responses from large language models (LLMs).

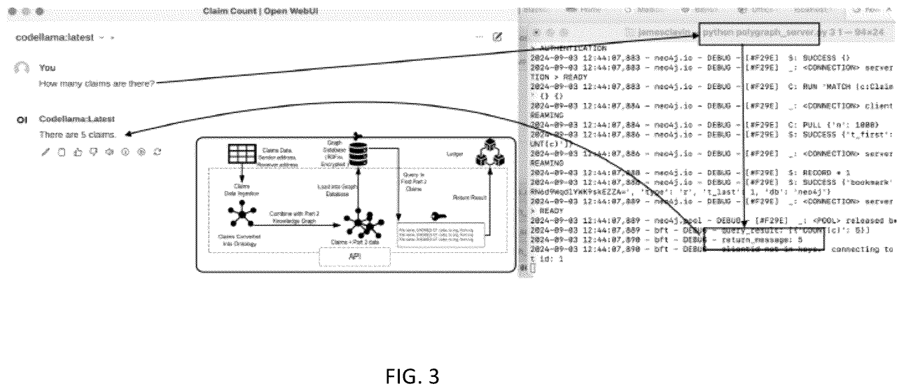

FIG. 3 is a depiction of an example framework using AI and blockchain technologies in accordance with embodiments of the present disclosure. Referring to FIG. 3, this framework can provide for the secure exploration of claims data and measurement of the cost of out-of-compliance data exchange. On the left side of FIG. 3 is an example displayed, user interface of a claims chat interface. The inset of FIG. 3 is a depiction of the architecture. On the right side of FIG. 3 is a BFT server. This client and server schema allows payers to examine healthcare claims data. Using electronic data interchange (EDI) formats mandated by HIPAA for claims processing, this system converts claims data into a knowledge graph, which can be linked to other clinical ontologies for data exploration.

From an easy-to-use user interface, a human prompted can be converted to a knowledge graph query through BFT consensus, and a result returned. In BFT, a system made up of n servers can proceed with safety (or security) and liveness (positive results) so long as it confirms to the rule that n>=3f+1, where f is the number of faulty or malicious processes. For example, in a system made up of four (4) servers, it can be safe if only one (1) server is faulty.

In embodiments, BFT protocols may be utilized to assure secure transactions or communications. The response from a BFT-backed query can be presented on a display to an individual, who can indicate whether it is accurate or not by providing reinforcement learning to the AI from human feedback. This can be a necessary step early in the adoption of systems and methods disclosed herein as it provides validation that the system is learning the organization's claims rules and nuances. In a cloud-based platform implementation, the infrastructure can be converted into cloud native solutions in a suitable cloud services platform, such as Amazon Web Services (AWS).

In embodiments, secure and resilient systems are disclosed that monitor, validate and explore the exchange of sensitive claims data, capable of integrating knowledge from external ontologies into the data to detect compliance issues with data exchange. In example, claims are detected that contain clinical information related to substance abuse and mental health by integrating terminology from the Substance Abuse and Mental Health Services Administration (SAMHSA). Operating in both batch and real-time modes, systems disclosed herein provide the following contributions:
Enables batch processing to verify adherence to agreed-upon data use policies between entities, focusing upon the use case of detecting SAMSHA related clinical terms being exchanged, which require a release of information consent from patients;
Calculates and monitors compliance costs for claims data exchange, converting Ethereum-based measures into dollar values; and
Provides a secure, real-time chat interface for claims adjudicators to query claims data and receive insights on the claims, as well as from external knowledge bases, such as SAMHSA Part 2 information.

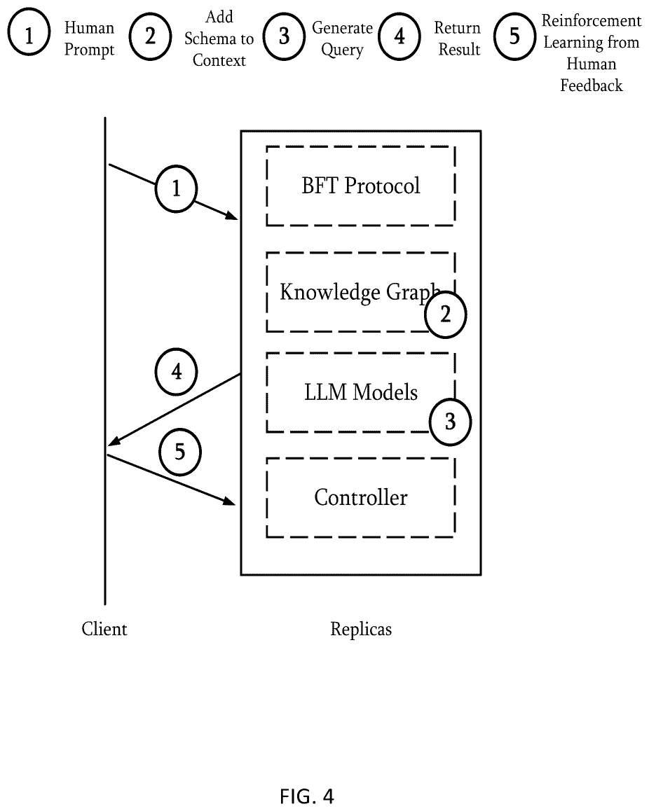

To ensure robust security and fault tolerance, Medical Data Polygraph introduces BFT GraphRAG, a novel integration of BFT and Graph-based Generative AI RAG. This framework upholds distributed system security through: use of two-layer consensus mechanisms; and enforcement of BFT consensus on RAG-augmented responses from large language models. The BFT GraphRAG workflow, illustrated in FIG. 4, which depicts a diagram of architecture and interaction flow of an example system in accordance with embodiments of the present disclosure. Medical Data Polygraph's effectiveness was assessed in anomaly detection within claims data in batch mode and evaluate real-time data exploration through secure chat functionalities, providing a foundation for advancing secure data exchanges in peer-to-peer networks

The network linkages for exchanging claims data in the U.S. have proven to be vulnerable to cybersecurity threats. Interlinked with clearinghouses are the covered entities themselves, and through this interlinking the attack space for threat actors expands exponentially. Any covered entity, such as CMS or a state Medicaid agency, a managed care organization (MCO), or a provider, with a connection to the Change Healthcare network was exposed to the threat by proxy. These threats continue to occur, with the 2024 MOVEIt secure file transfer breach causing millions of Medicare beneficiaries' personal information to be compromised.

Security threats are not the only means by which claims processing can be disrupted. There exist sub-systems internal to organizations, such as those at the Veterans Administration (VA), whose sole purpose is to validate claims, by looking for fraud waste and abuse, and then request payment from patients and third parties.

Those sub-systems can cause significant impact to revenue capture when they are not available or functioning as designed. In 2024 the VA reported a loss of revenue capture exceeding $600M caused by a claims program integrity application having faulty logic.

These kind of system defects are understandable given the volume of claims data being processed. In the case of the VA sub-system failure, between February 2023 and July 2024, there were 40M claims, and this was for just one category of claims, called community care—which is care received by veterans outside of VA medical facilities in specific situations. Given the volume of data in order to gain any adaptive real-time analysis of claims data is remarkably challenging. The small scale application of Generative AI on a case by case basis has proven successful; in the claims processing data flow, such as assisting providers in requesting or appealing preauthorization decisions, GenAI can assist with drafting appeal letters by integrating a patient's clinical data with the forms required by insurers.

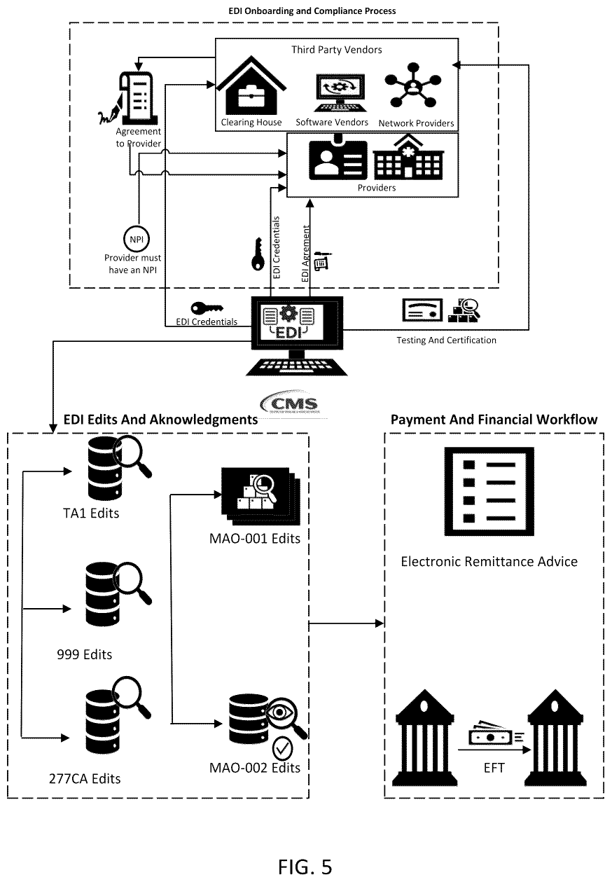

FIG. 5 illustrates a diagram of the CMS Medicare claim process, wherein providers submit claims, which undergo validation, and receive payments for accepted claims via electronic funds transfer. Network participants must register and certify themselves, and priority is given by all participants to protecting beneficiary data. Connectivity and communication details streamline CMS 837 EDI transactions. The com-prehensive process includes submitting claims, receiving payment details through Electronic Remittance Advice (ERA) or Standard Paper Remittance (SPR), and utilizing electronic funds transfer for faster, secure transactions. The EDI system ensures privacy compliance, safeguarding Personally Identifiable Information (PII).

Key requirements include acquiring a National Provider Identifier (NPI), validating it on CMS Provider Enrollment, Chain, and Ownership System (PECOS), and regarding the EDI number/password as an electronic signature. Third-party engagement necessitates signed agreements and the fulfillment of a third-party agreement form. Robust security measures encompass controlled access and exclusive EDI access for Clearinghouses and third parties. CMS 837 EDI Certification involves rigorous testing for accuracy, encouraging vendors to perform initial testing. It also certifies vendors, ensuring compliance for seamless EDI transactions with Medicare. Successful completion allows submission of production claims after 10 days. The Connectivity/Communications in CMS 837 EDI involves submitting claims via ANSI ASC X12 837 through SFTP.

Business rules, referred to as “edits,” and acknowledgments are core components of the claims submission workflow. Edits are categorized as either front-end (EDFES) or back-end (EDPS) edits, each serving a different role in enforcing the integrity of the healthcare claims process.

For front-end edits, the Syntax Level (TA1 Edits) validates the interchange control structure, promptly issuing a rejection (“R”) for any syntax errors identified. The Functional Group Level (999 Edits) provides evaluation of the syntactical correctness of functional groups and generates a comprehensive report that denotes acceptance, rejection, or partial acceptance. Transitioning to the Transaction Set Level (277CA Edits), these edits form the Combined Common Edits/Enhancements Module (CEM), where the validity of data elements within transaction sets is tested. The resulting 277CA report acknowledges acceptance or rejection and provides detailed errors.

Back-end edits, encapsulated in EDPS (Encounter Data Processing System), play a pivotal role in refining the integrity of encounter data. The Encounter Data Duplicates (MAO-001 Edits) are designed to identify and report on duplicate errors in encounter submissions. This involves rigorous checking at both header and detail levels, employing sophisticated algorithms such as hash totals and cross-referencing critical values. Encounter Data Processing (MAO-002 Edits) categorize encounters into “Accepted,” “Rejected,” and “Informational” edits at both the encounter and service line levels. These edits ensure the uniqueness and accuracy of submitted encounters and also provide detailed error information, providing information to submitters to correct errors and resubmit.

Medicare issues Electronic Remit Advice (ERA) or Standard Paper Remit (SPR) after processing claims, providing detailed adjudication and payment information. ERAs and SPRs cover multiple claims, offering itemized details with adjustments at the line, claim, or provider level. Adjustment reasons use Claim Adjustment Group Codes (Group Code), Claim Adjustment Reason Codes (CARC), and Remittance Advice Remark Codes (RARC). Group Codes assign financial responsibility, CARCs provide general explanations, and RARCs offer additional specificity. Medicare beneficiaries receive a Medicare Summary Notice indicating their financial responsibility based on these codes. Providers use free Medicare software like PC Print and Medicare Easy Print (MREP) to access detailed ERAs in the X12 835 version 5010 format.

Electronic Funds Transfer (EFT) allows direct payment to providers' financial institutions regardless of submission method (electronic or paper). To enroll, providers complete the EFT authorization form, included in the Medicare enrollment package, facilitating direct deposits within two weeks. Medicare contractors use ACH or ASC X12 835 version 5010 for electronic payments.

EDI forms the financial lifeblood of claims data being exchanged and it would be difficult to quantify in data storage terms just how much data is generated by EDI on a daily basis. It is known to be integral to healthcare payments because of the impact of EDI processing failures, such as the Change Healthcare cyberattack (described in Exchange of claims data in non-EDI format is permissible under HIPAA if the data is strictly prescribed to meet either operational or research purposes. In these instances, data use agreements are developed between two or more organizations which establish legal trust and dictate how protected health information (PHI) may be exchanged. Additionally, data use agreements (DUAs) specify what may be included in the data exchange, for how long the data may be stored, how to securely store and eventually destroy the data. Determining if the data exchanged adheres to DUA's, specifically whether or not the allowed data is correct, falls to the participating organization's to monitor. In the event disallowed data was exchanged, both organizations determine how to address the issue while complying with the DUA and HIPAA. Determining how and when these instances occur is a costly endeavor and requires unique domain knowledge.

One example is the exchange of particularly sensitive information, known as HIPAA “Part 2” data. 42 CFR Part 2 safeguards the confidentiality of substance use disorder (SUD) treatment records, encouraging individuals to seek help by addressing discrimination and legal fears that may deter treatment-seeking. The legal authority for this regulatory action is Title 42, United States Code (U.S.C.) 290dd-2, which safeguards the confidentiality of records related to federally assisted substance use disorder programs. The rule aims to prevent adverse consequences, such as criminal penalties, for individuals seeking SUD treatment. By restricting the disclosure of SUD information by federally assisted Part 2 Programs, the regulation shields patients from negative outcomes, including loss of employment, housing, child custody issues, and discrimination by medical professionals or insurers. In response to significant changes in the healthcare system, modifications in 42 CFR Part 2 align regulations with advances in integrated care models and electronic in-formation sharing while maintaining essential privacy protections. This revision is crucial to ensuring that patients with substance use disorders can participate in and benefit from healthcare delivery improvements and integrated models without fear of unintended consequences.

Violation of HIPAA Part 2 carries severe penalties, notably the § 2.3 Criminal Penalty for Violation, under 42 U.S.C. 290dd-2(f). Anyone found in violation of these regulations may face fines in accordance with Title 18 of the U.S. Code. Additionally, repercussions for breaching HIPAA Part 2 extend beyond fines, involving the provisions of sections 1176 and 1177 of the Social Security Act [42 U.S.C. 1320d-5, 1320d-6], similar to their application for breaches in Title XI of the same Act. These legal consequences emphasize the importance of adhering to HIPAA Part 2 regulations.

The healthcare industry maintains its unfortunate lead as the sector with the highest data breach costs, reaching an average cost per breach of USD $10.93 million in 2023, an 8.2% increase from the previous year; since 2020 the average breach cost surged by 53.3%, emphasizing the persistent financial impact and regulatory challenges faced by the industry. The Office of Civil Rights (OCR) tracks HIPAA violation cases, involving confirmed breaches and settlements, and has enforced monetary penalties ranging from $100,000 in 2008 to $3,536,500 in 2023. These penalties enable covered entities and associates to address violations without admitting liability, reflecting the dynamic evolution of HIPAA enforcement.

A streamlined response to data breaches, with identification and containment within 200 days, results in an average cost of USD $3.93 million, whereas breaches extending beyond 200 days incur higher costs at USD $4.95 million-a 23% difference. There exists therefore significant financial incentive for a shorter breach life-cycle, translating to a cost savings of USD $1.02 million per incident; there has been a trend towards faster resolutions over time. Breaches that cross the minimum threshold of 500 patients, as per the HIPAA Breach Notification Rule, 45 CFR §§ 164.400-414, require notification to the federal government. Systems that can detect issues earlier can reduce the likelihood of a breach; and those that provide full audit trails allow for identifying the full impact of any data compromise. Soon, with the Trusted Exchange Framework for national protected health data exchange coming online, qualified health information networks will have participants such as individuals and software companies that will make prompt notification of all stakeholders within five days of a breach, coupled with an elucidation of the breach's ‘natural and likely scope’, all the more challenging.

Currently only one-third of companies discover data breaches through their own security teams and tools, highlighting a need for better data loss prevention. 67% of breaches were reported by a benign third party or by the attackers them-selves. When attackers disclosed a breach, it cost organizations nearly USD $1 million more compared to internal detection alone.

The time, money, and effort required for traditional HIPAA compliance procedures are substantial. By streamlining and improving the process, automation can cut down on both the time and expense associated with HIPAA compliance. The steps involved in attaining HIPAA compliance are risk assessment, protection implementation, appointment of a compliance officer, employee training, upholding business associate agreements, creating breach notification procedures, and continuous audit documentation. Being certified against healthcare security standards such as the HITRUST Common Security Framework can cost organizations between $70K and $160K annually depending upon the organization's risk profile, take anywhere from six months to a year and half, and must be renewed every two years. Continuous monitoring, protection enhancement, employee training, and documentation are all necessary to maintain compliance. Depending on the organization's size, current data security, and requirement for outside consultants, the cost of HIPAA compliance without automation varies. Consultation fees, security tools, training, and vulnerability scanning are examples of potential costs. Smaller businesses might pay about $12,000 annually, but larger businesses might face recurrent expenses of hundreds of thousands of dollars.

Byzantine Fault Tolerance (BFT) is a core primitive behind blockchain technologies for ensuring system safety (nothing bad happens) and liveness (something good will eventually happen). To provide safety and liveness, any network made up of several nodes may have 3f+1 nodes to overcome f failures. For instance, a BFT network can be made up of 4 nodes to withstand 1 failure, or 7 to withstand 2. This is intuitive, but the underlying principle proves difficult to reason about any research has been done to make BFT architectures more accessible when designing blockchain based networks for the power grid, government apps and healthcare solutions. However, the direct application of BFT in domains, such as healthcare, tends to be limited to solutions that purport to utilize blockchain, which—in turn—are comparatively limited to other products and platforms. In part this is a result of the cost of running BFT, when compared to crash fault tolerance (CFT) solutions. CFT requires only one-half of servers to remain fault-free, so in a system with a primary and backup (2 servers), only 1 must be available. Further, cloud solutions offer well architected infrastructure designed to minimize service disruptions essentially out of the box.

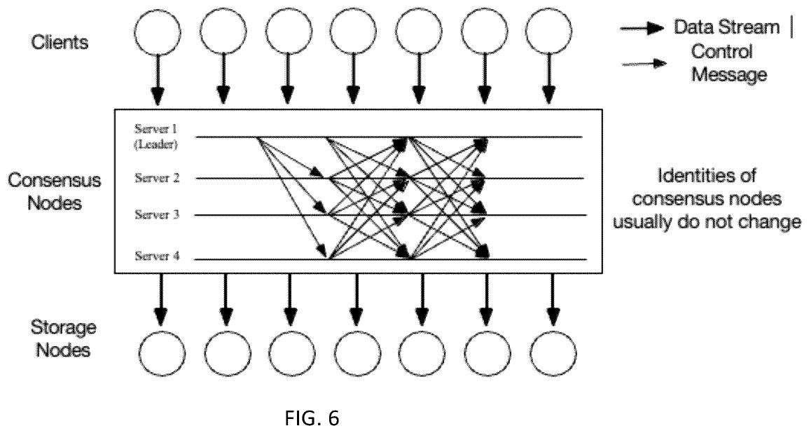

Byzantine Fault Tolerance (BFT) is deemed as the model for permissioned blockchains and can also be used to improve permissionless blockchains (hybrid blockchains). The workflow for BFT consensus is shown in FIG. 6, which illustrates a diagram depicting operation for a permissioned blockchain running a BFT protocol Practical Byzantine Fault Tolerance (PBFT), where control messages refer to message for nodes to reach a consensus. A BFT protocol assumes n servers which tolerates up to

$$f = ⌊ \frac{n - 1}{3} ⌋$$

failures. A quorum of

$$⌈ \frac{n + f + 1}{2} ⌉$$

votes from different nodes are needed to reach consensus.

The goal of BFT consensus is that the correct replicas reach a consensus on the order of client requests. Beginning with PBFT, an impressive number of efficient BFT protocols are propose. Numerous efforts have been made to improve the performance of BFT using different approaches. Most BFT protocols assume partial synchrony to guarantee liveness. Such protocols may have zero throughput in an asynchronous environment. In comparison, asynchronous protocols do not suffer from this problem. The BFT library BFT-SMaRt is a protocol that assumes partial synchrony.

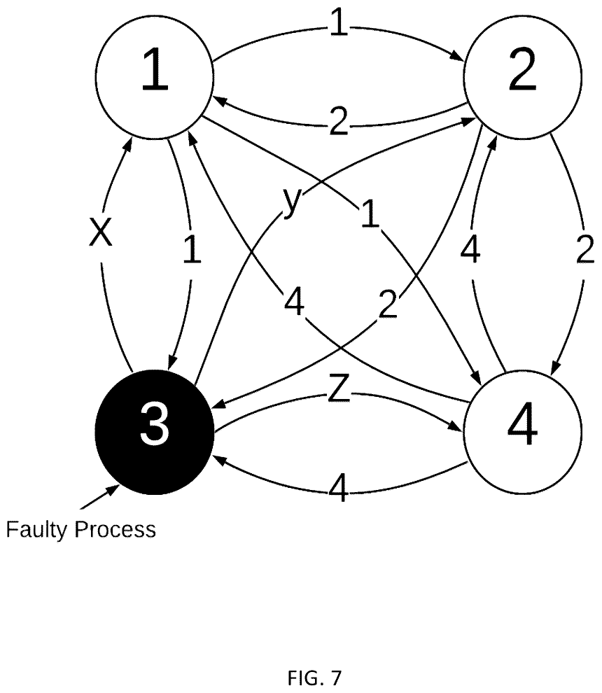

In a system with n nodes, an adversary can manipulate correctness only by controlling one-third or more of n. FIG. 7 illustrates a visual representation of this. A typical Byzantine Fault Tolerant (BFT) protocol assumes n servers which tolerates up to

$$f = ⌊ \frac{n - 1}{3} ⌋$$

failures. A quorum of

$$⌈ \frac{n + f + 1}{2} ⌉$$

votes from different nodes are needed to reach consensus. Although this seems perfectly straightforward, understanding how arbitrary faults manifests in real systems is challenging. The first system to implement BFT was Practical Byzantine Fault Tolerance (BFT).

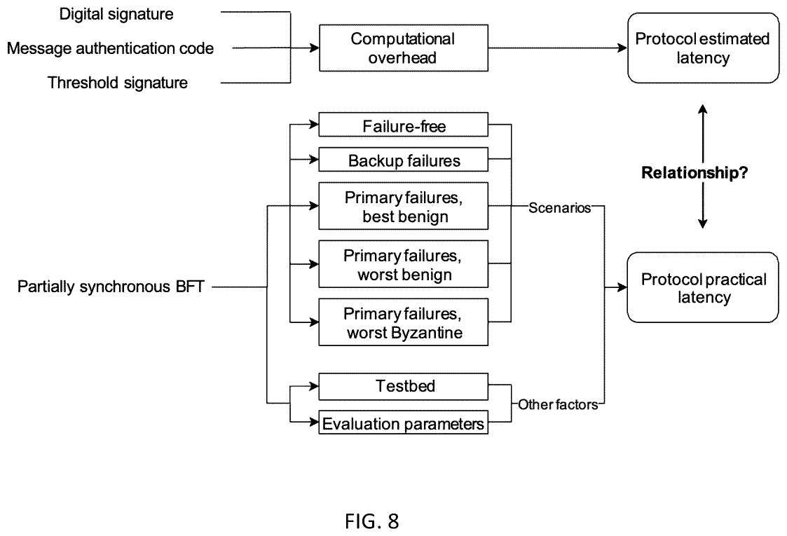

FIG. 8 illustrates a diagram of a framework for evaluating BFT protocols.

As shown in FIG. 8, a framework quantifies the performance of BFT by analyzing the accurate number of cryptographic operations in different scenarios. Previous studies showed that the number of cryptographic operations is directly related to performance, especially latency, in local area networks (LAN). Further-more, most studies only discuss the authenticator complexity in general, rather than the concrete number of operations. In contrast, we provided a customized framework that considers multiple scenarios.

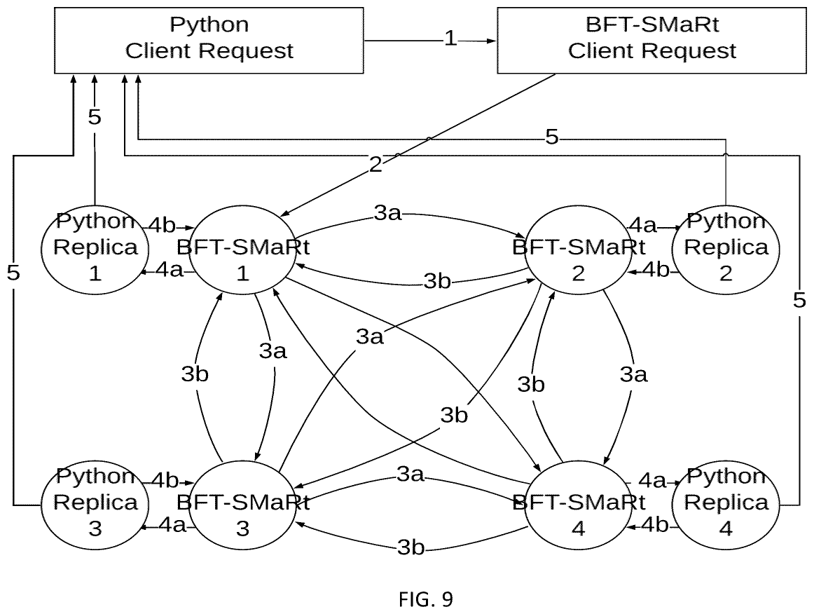

BFT-SMaRt is an open source java-based BFT library that has an API for re-use in other applications by either clients or servers. Clients can send messages using total ordered or unordered multicast, either synchronously or asynchronously. The API provides the ability for an application to decide how to execute client messages, perform state transfer, and what message to send in reply. The API provides the ability for an application to execute client messages, perform state transfer, and define what message to send in reply. A Python shim can interact with BFT-SMaRt through network sockets using JPype. The shim includes a sender thread that relays a message through the socket to a receiving replica thread. The receiving thread handles the request and sends back a message indicating that the request was processed. FIG. 9 is a diagram of the communication process, with 4 servers (referred to as replicas) running BFT-SMaRt, each with a Python shim.

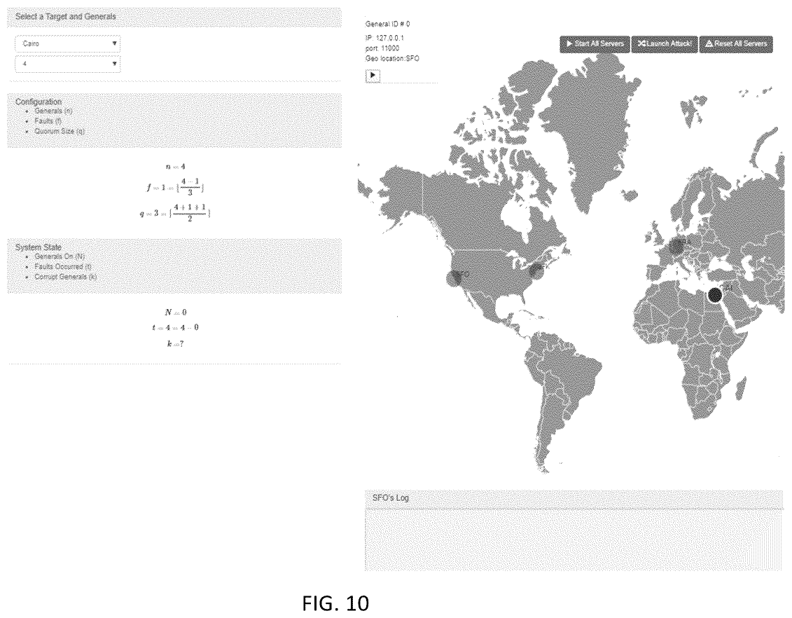

Despite decades of research, BFT consensus still is not easily comprehended. The consensus theory alone is difficult to understand, much less whether an implementation matches the theory, as observed from multiple previous efforts. To address these challenges ByzGame was created, a web-based application that connects a web frontend with a BFT implementation using BFT-SMaRt. ByzGame enabled users to directly configure replicas, run the BFT-SMaRt protocol, and visualize the message flow. Users could do real world tests of the theory of BFT consensus, learn the basic concepts about BFT, examine the BFT implementation, and identify issues with the protocol. As illustrated in FIG. 10, the main interface had three components: user configuration, visualization, and system log.

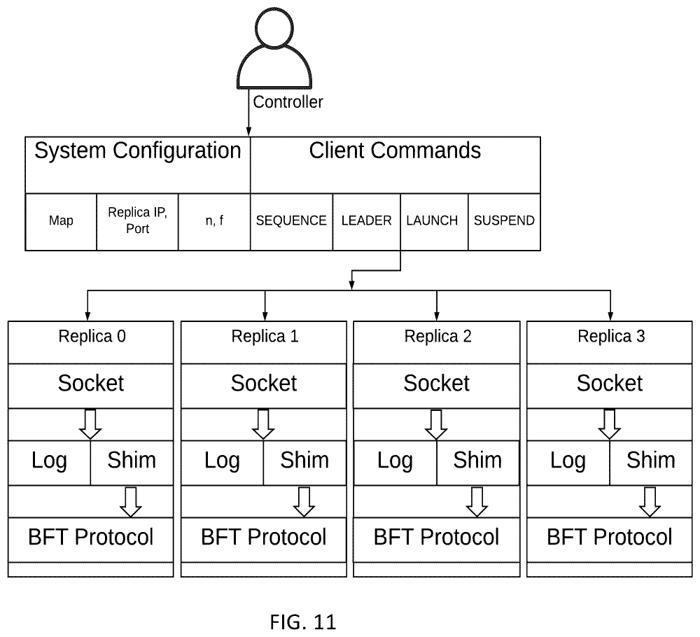

FIG. 11 illustrates a diagram of a ByzGame system model. The user configures the system parameters and initializes its state, and they can configure each replica in the system, and change each one's system state.

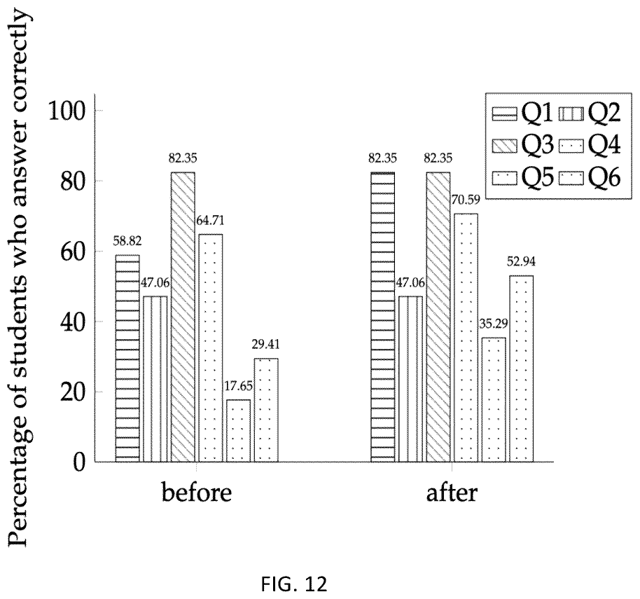

The application was proven to improve understand of BFT protocols by testing it with subjects. It was determined that their understanding of BFT systems changed, improving after working with ByzGame; before and after survey results are available FIG. 12, which depicts graphs showing the percentage of subject teams who answer the questions correctly before and after showing ByzGame. For the Medical Data Polygraph, this research provided the experience necessary to wire together a BFT protocol with a front-end application.

Supervised machine learning models as part of a two-layer consensus for detecting fake news established a framework for the Medical Data Polygraph. Fake news detection models were developed that used Logistic Regression (LR) and Support-Vector Machine (SVM) running on BFT nodes and observed the effects of (temporary) failures or attacks, causing some nodes to “fall-behind,” and requiring an efficient machine learning state transfer protocol to bring such replicas up to date. This two-layer consensus was provably secure and showed that two-layers requires a combination of automated machine scoring and human expert reviews, which is similar to chat-based large language model's integration of reinforcement learning from human feedback (RLHF).

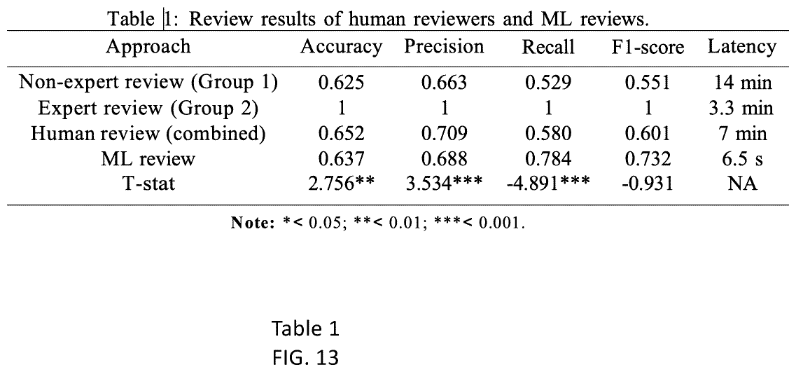

As shown in Table 1 shown in FIG. 13, human reviews achieve higher performance than ML in accuracy and precision but have the main drawback of long latency. Additionally, one observes that the results of experts (group 2) are consistently higher than those of non-experts (group 1), while ML outperforms the non-experts by every measure.

The Ethereum blockchain represents a finite state machine, and is recognized for its ability to support chaincode, or smart contracts, on chain so that any network participant can attempt to utilize the contract, if the participant has permission and enough Ethereum for the transaction, referred to as the gas price, to execute the contract. Smart contracts are programs that automatically fire when nodes come to consensus, without any human intervention. Smart contracts are not the normal contracts people use. Instead, the nodes in a blockchain are configured to check a series of conditions to see whether the triggering criteria has been met. If the requirements are met, then the nodes execute an agreed upon contract, a program that executes business-defined functions. Smart contracts allow users to deploy new capabilities and functions while the blockchains are running; services do not have to be stopped. Specifically, developers can write a new smart contract that includes a set of functions. After the contract is deployed on the blockchain, authorized users could call the contract to use those functions. Other running services on the blockchain do not have to be interrupted at all to support these new functions. The most popular smart contract platforms include the Ethereum Virtual Machine (EVM, written in a language called Solidity) and Hyperledger Fabric's Chaincode (written using a combination of the languages Go, node.js, and Java). Since all blockchain transactions are included in a linked list, or (hash chain), and therefore unchangeable, having a bug in the contract, or a flaw that can be exploited, introduces risk into the system. It is noted that the use of smart contracts will likely degrade the performance of the system, as observed by several research papers. A local version of Ethereum was implemented and examined how to integrate it with knowledge graphs for automating GDPR compliance checks.

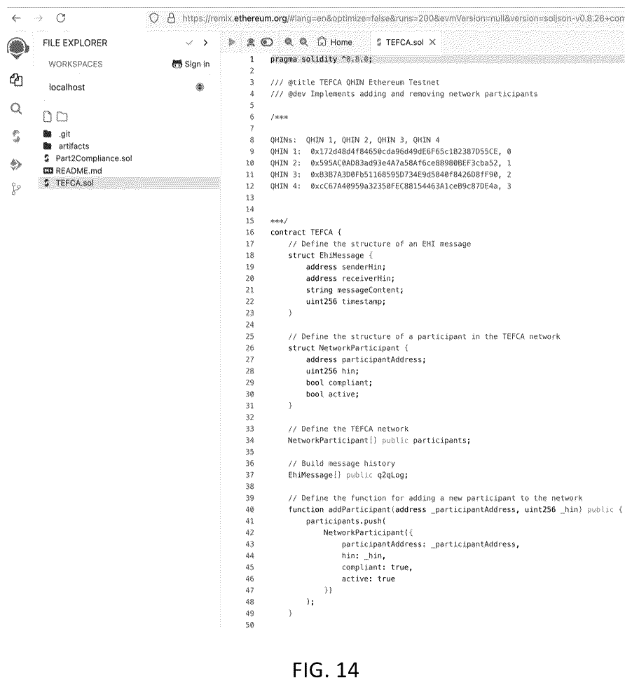

Smart contracts are human readable code converted into ABI code and byte code that can be executed by an Ethereum account that pays the price, known as gas, to run it. The online integrated development environment, Remix compiles smart contract programs written in the Solidity programming language (files ending with .sol in FIG. 14, which shows codes of remix connected to localhost), and generates ABI and byte code.

For the Medical Data Polygraph, measuring the cost of out-of-compliance ex-change in Ethereum means setting up a test network (testnet) running nodes where we can deploy smart contracts, which can then be used by health organization to record data exchanges.

Knowledge graphs are used to support domain specific reasoning using machine readable data. Developing ontologies to capture knowledge in classes with attributes enables a machine to reason by inference or query. Knowledge graphs have been used to extract knowledge about the security and privacy provisions included in HIPAA. These ontologies can be built in languages such as Resource Description Framework (RDF) and Web Ontology Language (OWL); applications such as RDFox and Neo4J are tools for reasoning over these structures. Resource Description Framework (RDF) and Web Ontology Language (OWL) are the most popular Semantic Web data modeling languages. These technologies can be used to provide common semantics of medical datasets and policies enabling all software agents who understand basic Semantic Web technologies to communicate and use each other's data and services effectively.

While exchanging sensitive datasets, organizations need to exchange information, queries, and requests with some assurance that they share a common meaning. This is critical not only for the data but also for the data protection policies followed by the organizations. The handling of heterogeneous policies is usually not present in a closed and centralized environment but is an issue in the open internet/cloud. The interoperability requirement is not just for the data itself but even for describing policies for data protection. One possible approach to this issue is employing knowledge graph techniques to model and reason about standards, such as the HIPAA Electronic Data Interchange.

Querying a knowledge graph can be achieved through the SPARQL Protocol and RDF Query Language (SPARQL) in the case the data is stored in an rdf or ttl format. If the data is stored in a Neo4j graph database, the Cypher query language is used.

Large Language Models (LLMs) have shown promise in assisting in biomedical applications, however, limitations exist in getting models to provide not only valid responses but consistent ones. To address these challenges, two approaches exist: one is to retrain the LLM on a unique use case or to leverage a context-generation method such as retrieval augmented generation (RAG) to ground the LLM.

First, fine-tuning LLMs has resulted in several publicly available purpose-built models, as listed at Hugging Face. This requires an investment in infrastructure, particularly nodes running expensive graphics processing units (GPUs). In addition, the time and effort to train the model is notable and requires an expert data scientist familiar not only with LLMs but also with whatever domain they are tuning the model for. Once an LLM like this is fine-tuned, then the model's parameters must be configured such that the desired responses are given most frequently. Settings such as “temperature” determine how random the response of the model is and is critical. The trade-off of such an effort against a more traditional AI where the cost-benefit analysis is more straightforward is nontrivial. E.g., building a logistic regression model, NLP model, etc. with a more predictable result may be more appropriate, depending on the use case.

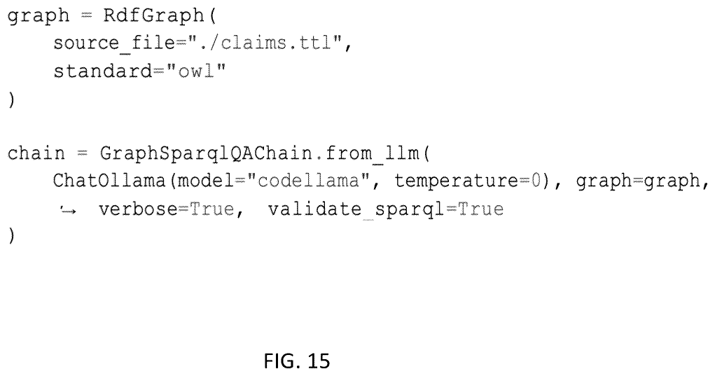

Second, at lower cost but also potentially less reliable than a fine-tuned LLM, is the use of retrieval augmented generation (RAG). RAG attempts to provide models with context to ground LLMs, and thereby reduce the probability of hallucination. One technique for RAG is to combine it with knowledge graphs, forming GraphRAG. In GraphRAG, the schema of the graph database is provided to the LLM, along with ontological data in the Resource Description Framework (RDF) or Web Ontology (OWL) format. By providing this additional context to a pretrained LLM that has been configured with known parameters (such as a fixed temperature), GraphRAG enables the LLM not only to interpret prompts, but to provide answers influenced by the additional context and built from the knowledge graph's associations and attributes. GraphRAG improves the accuracy of the LLM and makes these models more extensible and maintainable due to its understandability. Many medical coding systems such as the Systematized Nomenclature of Medicine-Clinical Terms (SNOMED-CT), International Classification of Diseases (ICD) and Logical Observation Identifiers Names and Codes (LOINC) have onto-logical components, to name but a few. Given the ontology-driven nature of many medical coding systems, there is an opportunity to integrate these into biomedical LLM applications through GraphRAG. In order to accomplish this, a programming language that can handle working with graphs and LLMs is necessary. The Python libraries langchain and llamaindex can programmatically combine graph data and schemas into the context of a prompt, translating the human prompt into syntactically correct queries for extracting subsets of data. Langchain achieves this by loading a raw data file, such as a Terse RDF Triple Language (ttl) file, into an Rdf-Graph object. FIG. 15 provides an example of loading claims data in ttl format into a graph, then creating a chat object using Ollama running the codellama model.

The Medical Data Polygraph makes use of langchain, simply due to it having been more popular sooner than the llamaindex solution. Either may work within disclosed herein.

Systems in accordance with the presently disclosed subject matter can include: raw claims data, claims knowledge graphs, external knowledge graphs such as clinical terminologies and taxonomies, graph databases to house the data, and blockchain to provide security and measure performance.

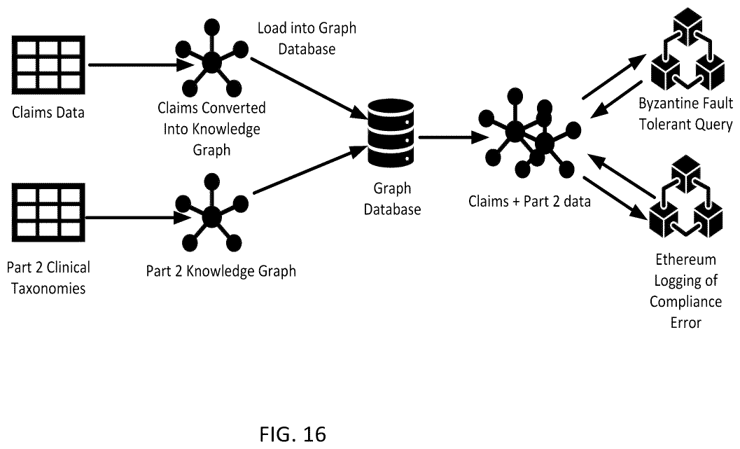

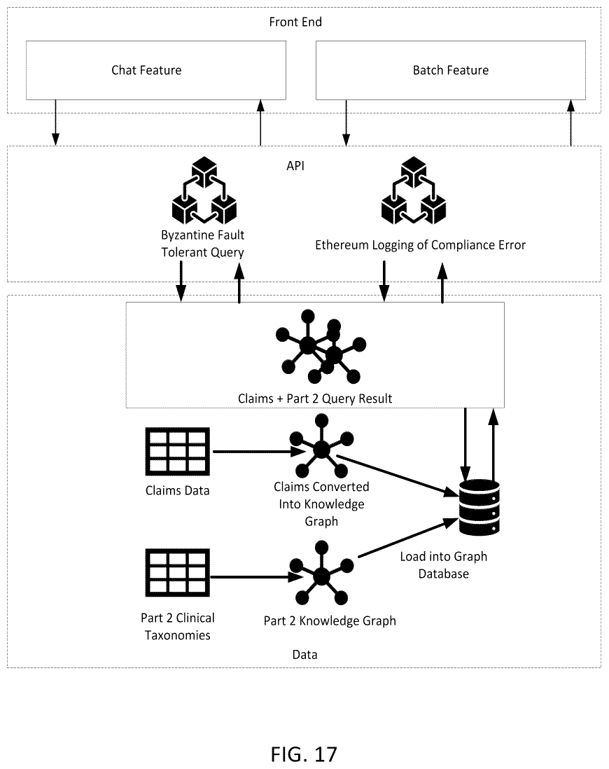

The system can combine the claims data with knowledge graphs that can be developed, in order to enable reasoning not only about claims themselves, but also about claims data in other contexts, such as demographic or clinical graphs that provide insight into geography or chronic conditions. The blockchain-based components (Ethereum testnet for batch, and BFT-SMaRt for chat) provide strong guarantees of security, as they are Byzantine Fault Tolerant. A comprehensive overview of how data flow and are accessed in the system is shown in FIG. 16, which illustrates a diagram of core components of a system in accordance with embodiments. This flow translated into a traditional three-tier architecture (front-end, API, and back-end) is displayed in FIG. 17, which illustrates a diagram showing API and various features.

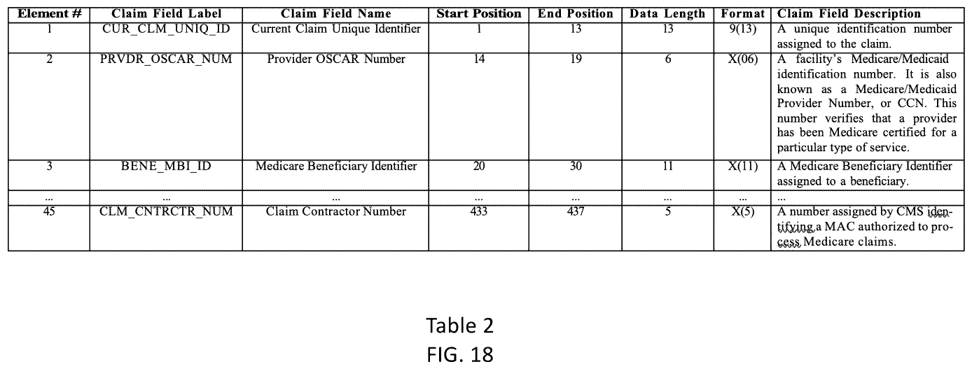

We categorize the types of claims data into two bins: ad hoc data and Electronic Data Interchange data. Ad hoc claims data are defined by an organization to meet a business objective related to claims that have already been, or are in process of, being paid. E.g., the Centers for Medicare and Medicaid Services maintains the Claim and Claim Line Feed data, which contains Medicare hospital, provider and prescription data in well-defined formats. There are several file formats, just one is shown in Table 2 depicted in FIG. 18, which contains an excerpt from the Part A (hospital) header file definition. The CCLF data is used for HIPAA protected activities such as operations and research. The data has proven useful in building artificial intelligence, such as predictive models that identify individuals risk of having an avoidable hospital event.

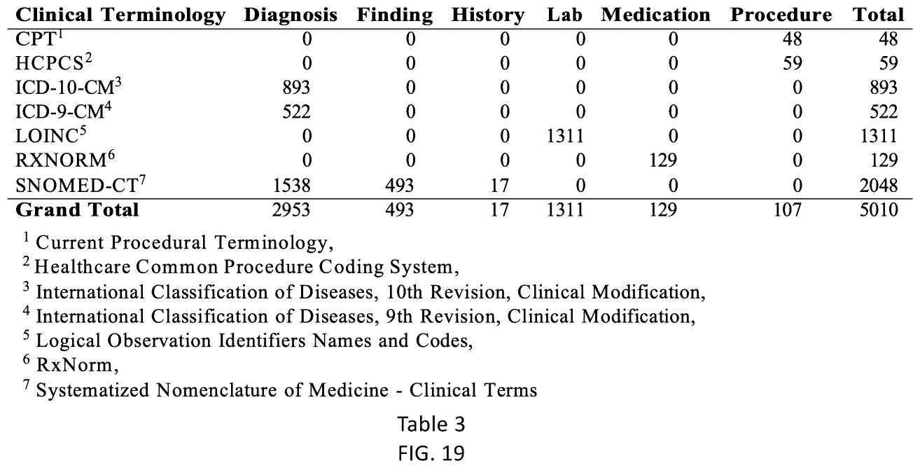

In research, a focus was identifying substance abuse and mental health claims data, or “Part 2” data. Therefore, there was a need for a definitive data set that identified which clinical terms, across taxonomies (lab, procedure, diagnoses) may be considered Part 2. The Substance Abuse and Mental Health Services Administration (SAMHSA) National Institutes of Health (NIH) value sets were gathered that capture the different clinical terminologies and whether they are considered Part 2 related. Table 3, shown in FIG. 19, lists Part 2 clinical terms by category.

Systems disclosed herein can utilize knowledge graphs because of the need for reasoning, their semantics are grounded in first-order logic and model theory, allowing programs to draw inferences with the assurance that the subsequent interpretation is sound. Knowledge graphs can provide sound and complete reasoning with various levels of reasoning complexity and can be integrated into retrieval augmented generation large language models. An additional design consideration is to provide standard semantics when handling claims information and when integrating external ontologies.

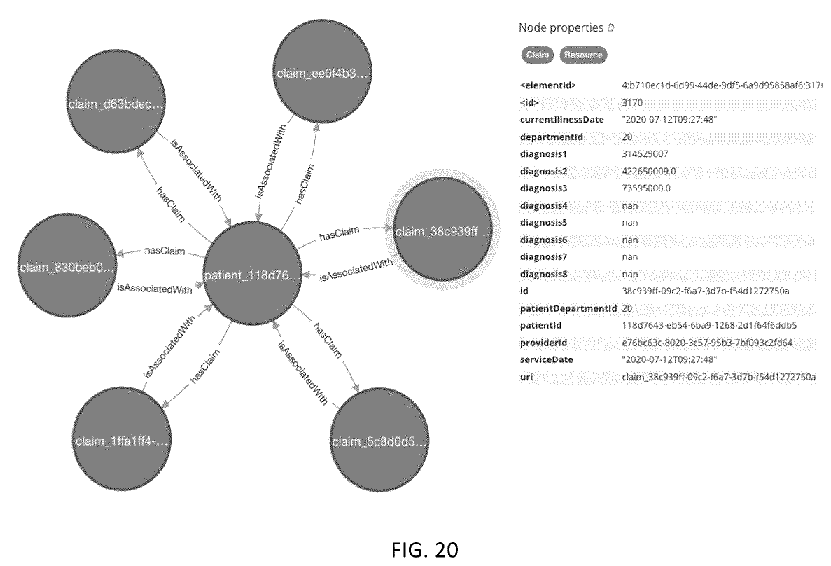

Converting claims data into a semantic form is a fundamental requirement of the Medical Data Polygraph to achieve interoperability at the syntactic and semantic levels in a manner that supports portability across healthcare systems. FIG. 20 is a diagram depicting modeling of ad hoc claims data in a graph format, where one patient has six claims; the highlighted claim's diagnostic information is shown inlaid.

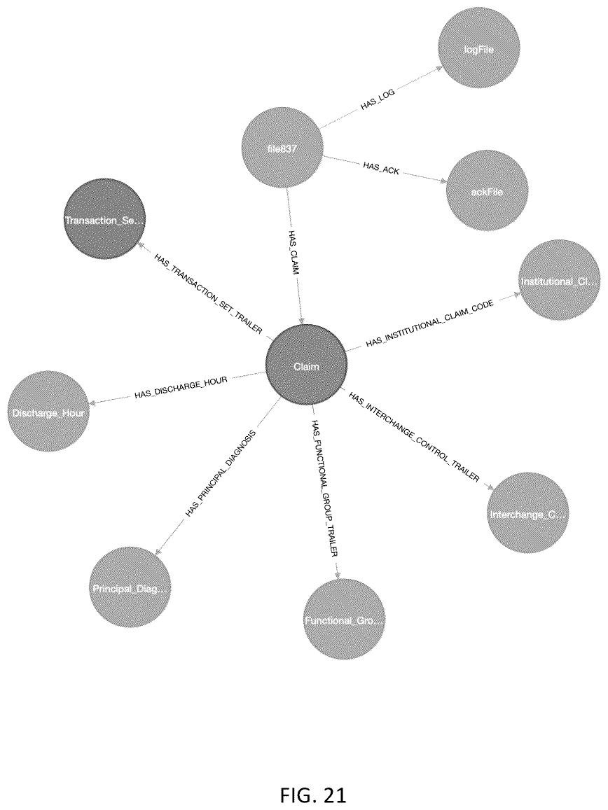

A graph model was also designed for ASC X12 837 claims data. FIG. 21 illustrates a diagram of an example of an 837 claim file as modeled in a graph database. Because the X12 format is hierarchical, based upon loops and segments, and because each loop and segment has attributes associated with them, nodes can be dynamically created and relationships given any set of 837 files (which could be professional, institutional, or dental). At the center of the EDI graph is one claim of many from an 837 file, with the relationships the claim has to its constituent segments and elements; and claim's principal diagnosis, discharge hour, transaction trailer set, and control trailer can be seen.

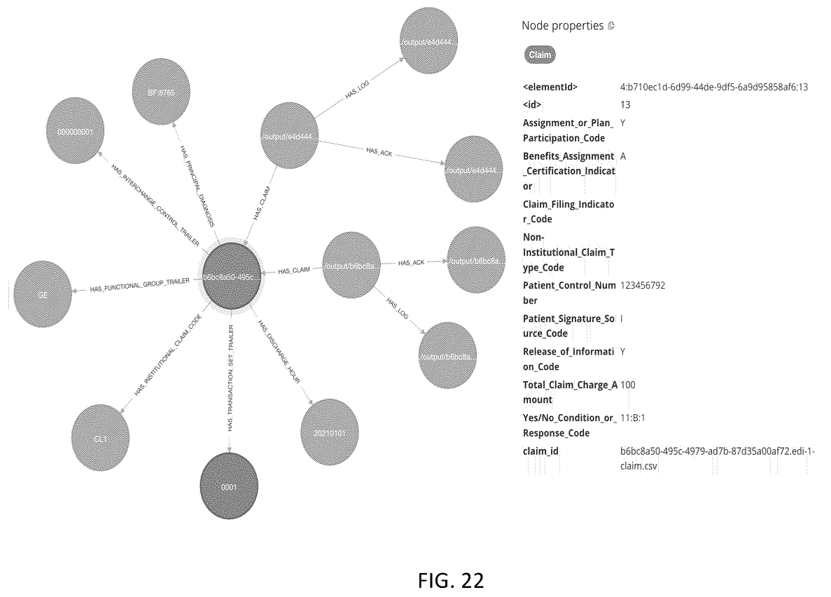

An instance of the 837 graph populated with EDI data populated is shown in the diagram depicted in FIG. 22 with the claim identifier at the center, and the claim attributes displayed on the right, including “Patient Control Number,” and “Release of Information Code” among others fields.

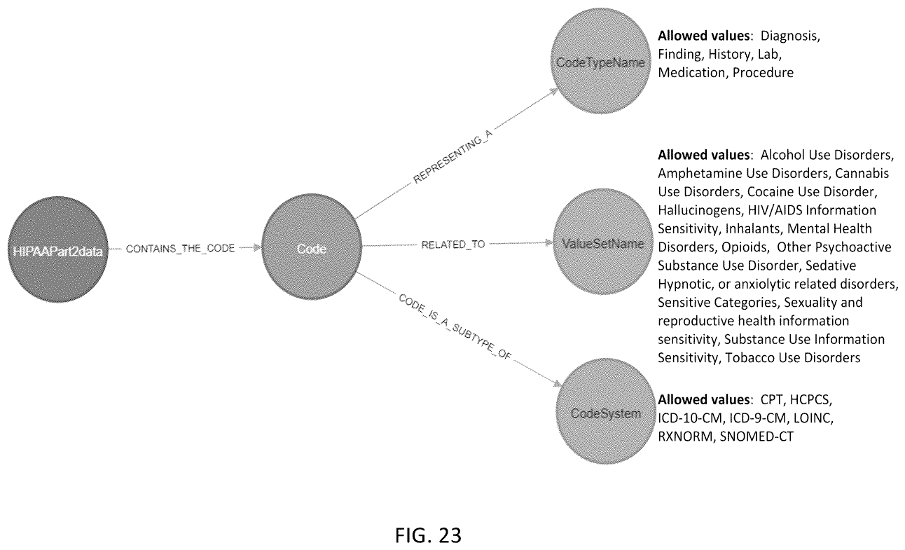

To find substance abuse and mental health claim data when it is contained within a much larger claims data set, a knowledge graph was created that encompasses National Institutes of Health (NIH) value set codes pertaining to substance abuse and mental health, as maintained by the SAMHSA. This is made possible by modeling the categorizations from Table 3 in FIG. 19, using them as the basis for a knowledge graph that encapsulates Part 2 clinical terms, as shown in FIG. 23, which is a diagram of a Part 2 knowledge graph. The graph captures any Part 2 patient experience using any clinical terminology system, including ICD, SNOMED, CPT, LOINC, and RxNorm.

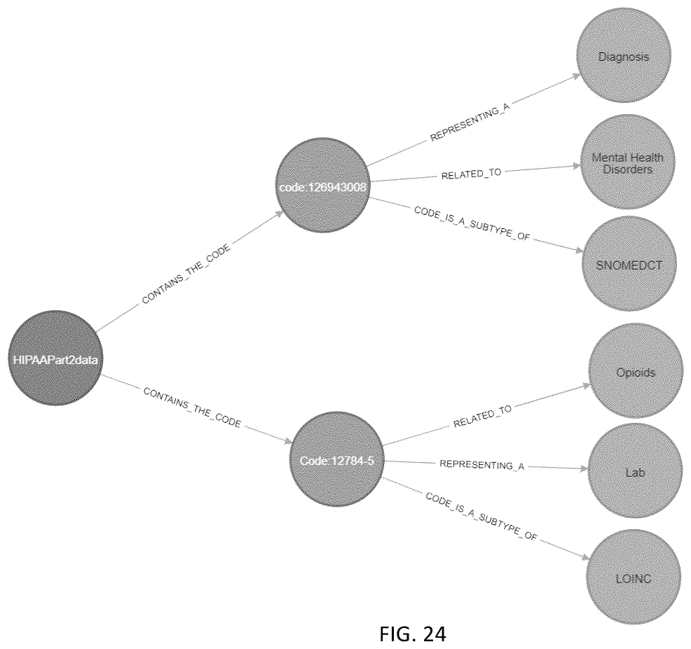

For example, FIG. 24 is a diagram of a Part 2 knowledge graph example that identifies opiod labs and mental health disorders diagnosis. Particularly, FIG. 24 demonstrates the graph populated with LOINC and SNOMED-CT terms for a Lab of Opioids and a Diagnosis of Mental Health Disorder. As administrative claims data contains billable information, including diagnoses codes in SNOMED-CT, derived from the clinical data present in an EHR, we can link the Part 2 graph with administrative data on the shared terminology; in this case SNOMED-CT.

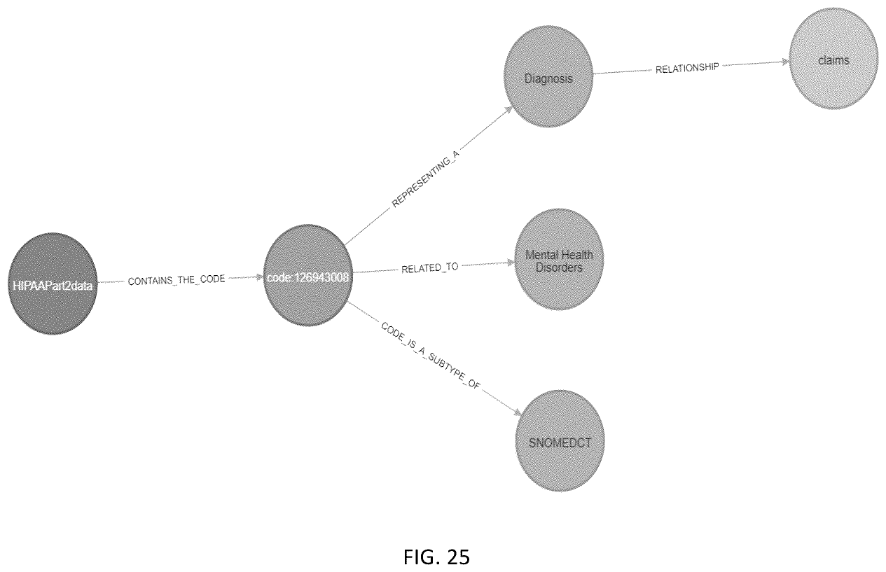

This enables the full exploration of claims data in unique ways, such as identifying heretofore unobserved associations as well as clustering of information. An example of such an insight into the patient experience and claims costs is presented in FIG. 25 (a diagram of a Part 2 SNOMED-CT code linked to a claim), where one could extrapolate that a mental health disorder has been linked to a claim; by extension the claim will contain patient demographic information, cost, and other pertinent attributes.

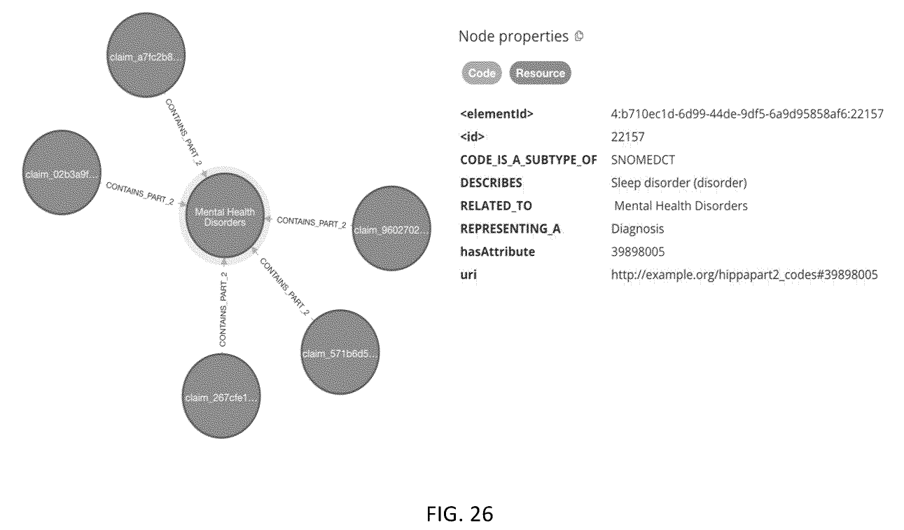

By combining claims and Part 2 graphs, and querying, we can find all claims associated to any mental health or substance abuse disorder. FIG. 26 is a diagram that depicts ad hoc claims with sleep disorders. Particularly, FIG. 26 demonstrates claims that have the relationship “CONTAINS_PART_2” to “Mental Health Disorders”, in this case “Sleep disorders.”

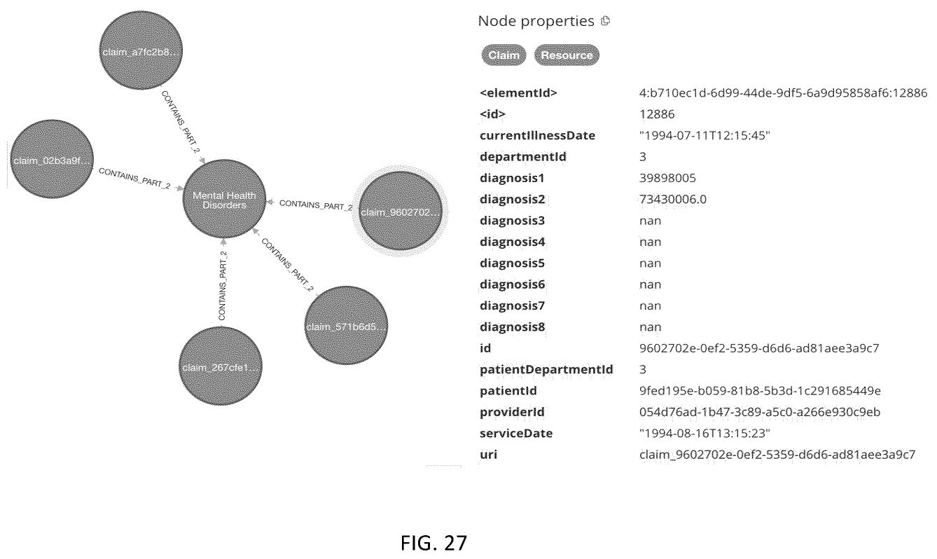

FIG. 27 is a diagram depicting sleep disorder ad hoc claim attributes. Particularly, FIG. 27 shows the details of one claim, including patient identifier, provider, the SNOMED-CT codes, and dates.

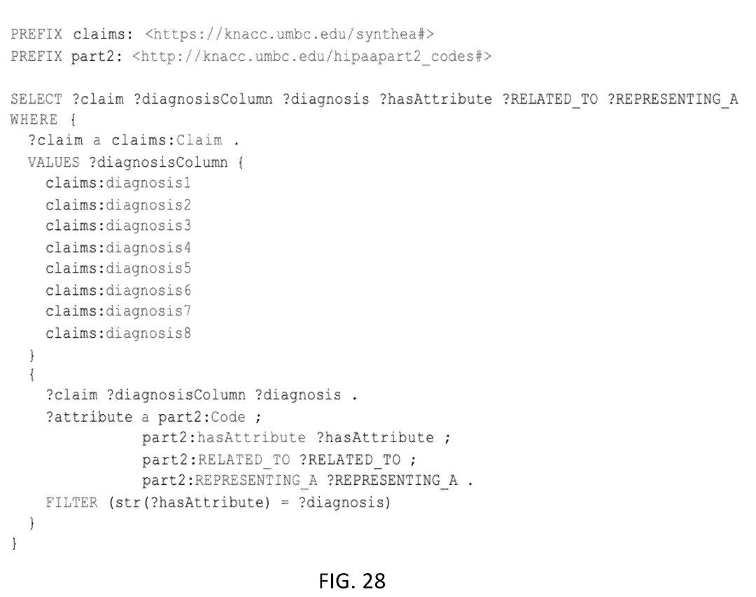

A SPARQL query against ad hoc claims data stored in RDF format, that identifies claims with a diagnosis related to a Part 2 clinical term is shown in FIG. 28, which is code for a SPARQL query to detect Part 2 data in ad hoc claims data.

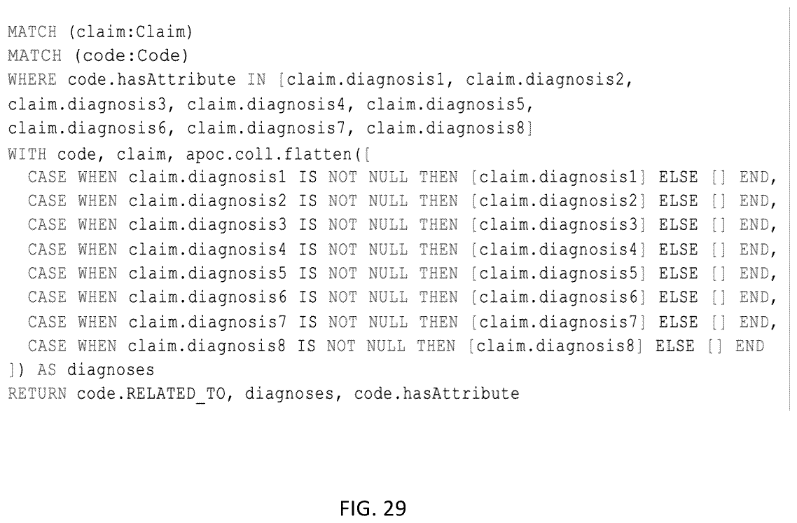

Using the same knowledge graphs, but with the ad hoc claims data loaded into a Neo4j data source, an equivalent Cypher query is shown FIG. 29, which is code for a cypher query to aggregate Part 2 data in ad hoc claims data. This demonstrates that two techniques (SPARQL and Cypher) can be used to find the same data, meaning any graph database will support the graphs and combining them.

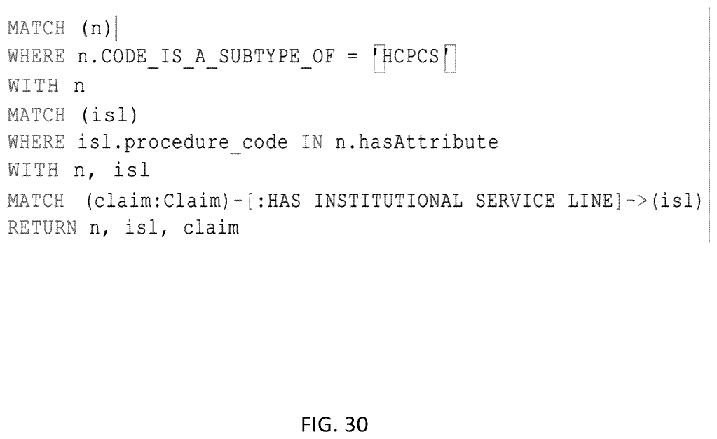

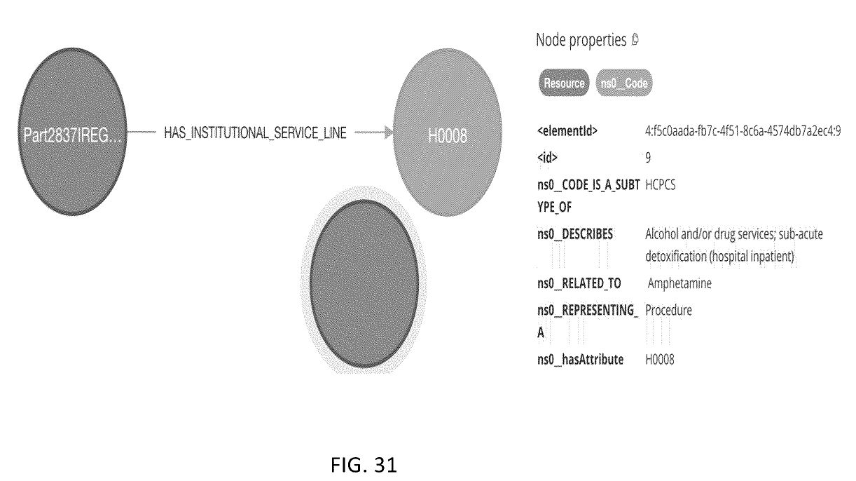

Unlike the ad hoc claims shown thus far, which have only SNOMED-CT terms, EDI data supports multiple taxonomies. For diagnostic coding EDI uses the International Classification for Diseases (ICD), and for procedures EDI utilizes the Healthcare Common Procedure Coding format (HCPCS). Part 2 graph disclosed herein captures both, and as a result when joined with EDI claims remains capable of finding Part 2 related information. The query shown FIG. 30 gets all Part 2 procedures from an EDI claims data set stored in a Neo4j graph database. The results of the query are shown as nodes FIG. 31, which illustrates query results from FIG. 30. The claim node is related to a service line with HCPCS code “H0008”; the code has been classified as “Alcohol and/or drug services; sub-acute detoxification (hospital inpatient).”

Systems disclosed herein can utilize blockchain in two ways. First, to achieve logging and measurement of the cost of data exchange which is out of compliance; we refer to this as “batch” mode. Second, by utilizing BFT to provide fault tolerant responses from LLMs when users ask natural language questions of claims data; this is referred to as “real-time” or “chat” mode, and is a manifestation of the idea of “Byzantine Fault Tolerant GraphRAG,” or “BFT GraphRAG.”

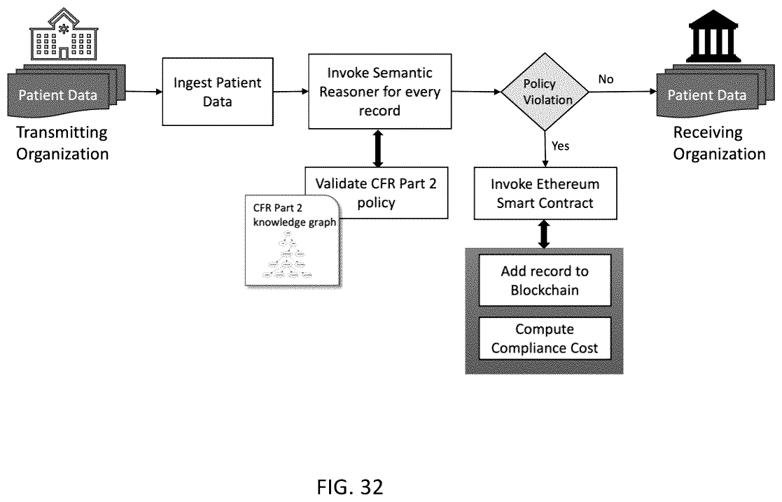

The batch claim data flow is shown FIG. 32, which illustrates a diagram of batch system architecture. Referring to FIG. 32, the figure depicts how patient claims data from a transmitting organization flows through to a receiving organization within the presently disclosed system.

For querying the data set of claims and determining if Part 2 data is included, RDFox can be used given its in memory knowledge graph feature enabling better query performance. Additionally, RDFox adapts to new information in real time through forward chaining and has an API for loading and querying graph data.

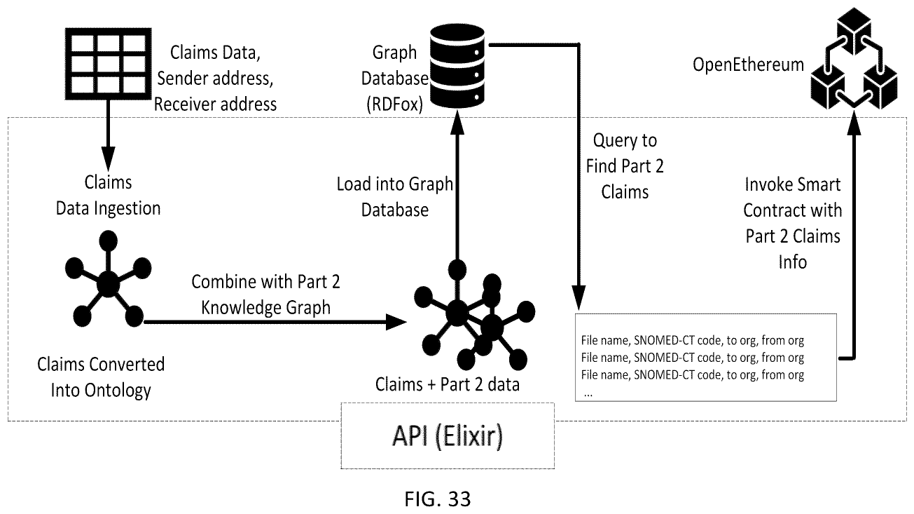

FIG. 33 illustrates a diagram of batch mode components. As FIG. 33 depicts, an Elixir API is provided for interacting with both RDFox and OpenEthereum, i.e. for both data loading/querying and smart contract invocation. The Elixir language provides significant fault tolerance and its web framework Phoenix is supported by an active open-source community.

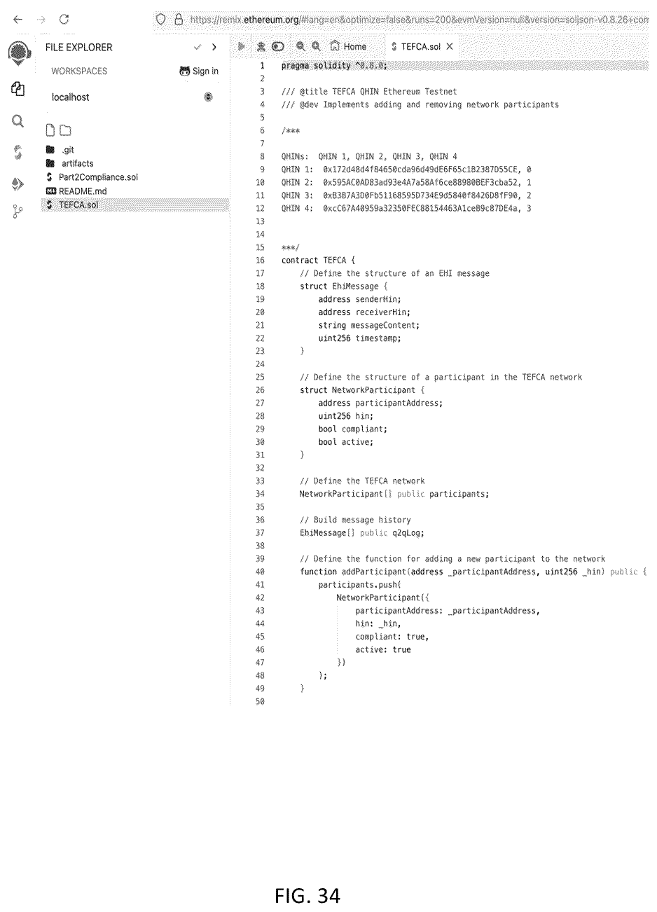

Elixir Ethereum libraries were utilized to load and invoke a smart contract Application Binary Interface (ABI), and to query the OpenEthereum blockchain to gather cost information in gas expended. To add our own compliance smart contracts to the testnet we developed Solidity code using Remix; an example of editing a contract is shown in FIG. 34, which illustrates software code for using remix to edit a smart contract as disclosed herein.

A smart contract that runs on this testnet and mimics the design of TEFCA is available in Appendix B. The contract takes as inputs: the sending organization Ethereum address, the receiving organization Ethereum address, and a list of Part 2 clinical terms in SNOMED-CT. As a smart contract component, the policy that is found to be in violation can automatically cease the data being exchanged by the parties, or at least raise the issue to the relevant organizational party at a much earlier date in order to take corrective action. In this way apparent cause errors are identified prior to causing a breach, as defined in HIPAA Breach Notification Rule, 45 CFR §§ 164.400-414.

The Elixir API code that invokes the smart contract is available in Appendix section E.1. Using an Elixir web client, a library was developed to integrate with RDFox, thereby enabling on-demand loading of ontological data into the graph database, and execution of SPARQL queries against the newly loaded data. The API code for interacting with RDFox is also in the Appendix, in section D.2.

Elixir benchmarking libraries enabled gathering performance metrics, inclusive of average time spent identifying Part 2 claims then logging them on the blockchain; this code is in Appendix section D.3. Last, for modeling exchange between healthcare organizations, as part of the API we created a TEFCA network (see Appendix section D.4).

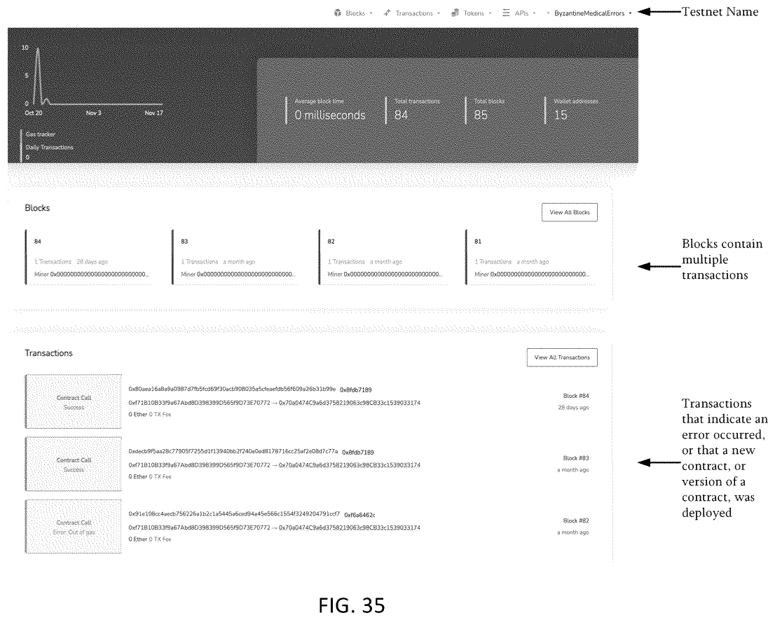

To enable visual exploration of the OpenEthereum testnet, we installed and configured the Blockscout chain explorer application. FIG. 35 is a screen display of an example batch user interface. FIG. 35 highlights where in Blockscout the testnet name is located; in these early experiments the name was ByzantineMedicalErrors. The user interface was designed to display recent block history, and to list transactions with their status of various compliance checks.

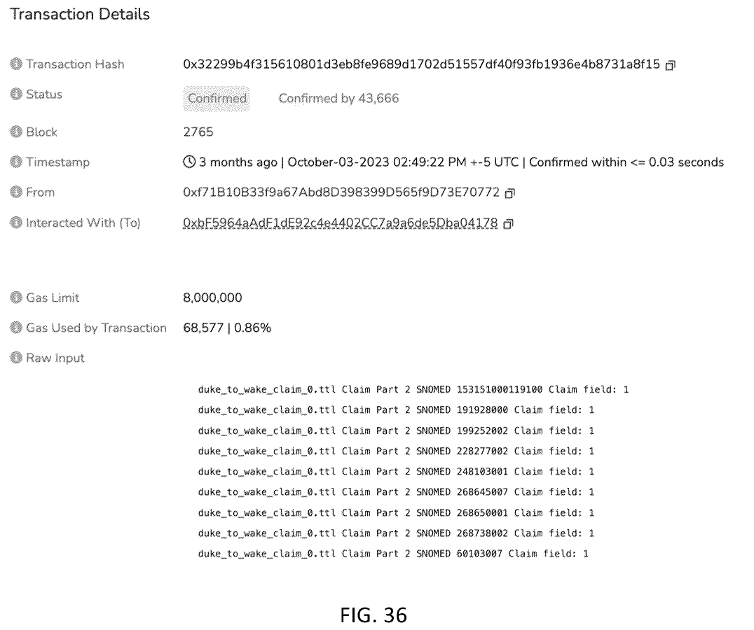

To see the details of a transaction, you can select it and bring up the screen as shown in FIG. 36, which depicts transaction details that show the files that had a Part 2 compliance issue, and which of the claims fields (there are seven in the ad hoc data) had the issue.

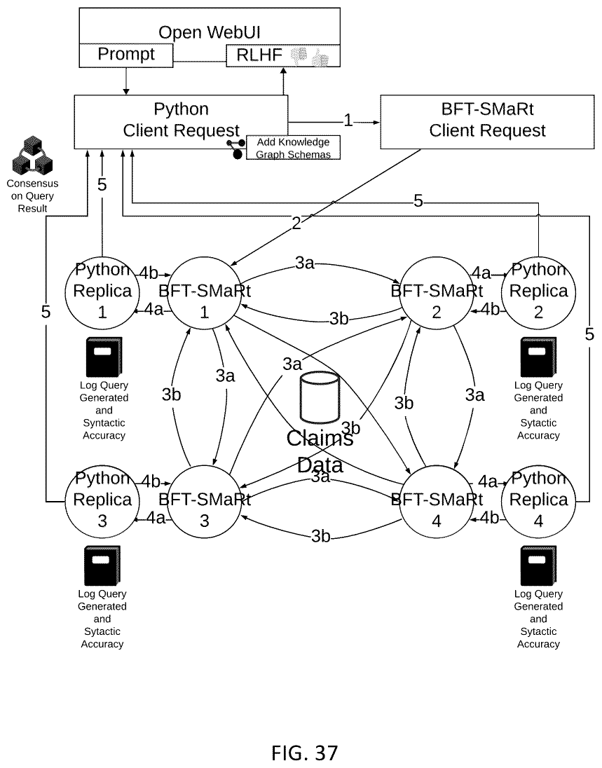

Previous work in detecting fake news through two-layer consensus utilized a ML layer running logistic regression that scored the probability of a supplied context being true or false based upon a ground truth data set. The system returns the score to the client and forwards the context to a human expert to determine whether the news is accurate. Once a minimum number of experts validated the result, the news veracity was considered final. This flow foreshadowed reinforcement learning from human feedback (RLHF) that is commonplace in chat-based LLMs today. Therefore, we integrated RLHF into the two-layer consensus to replace experts, assuming the client is the expert and that clients that form a majority finalize the context being true or false; this adaptation is shown in FIG. 37, which illustrates a diagram of system shims in accordance with embodiments of the present disclosure.

To examine the portability of the HIPAA Part 2 graph to other graph databases besides RDFox, as well as to test the Medical Data Polygraph's ability to generate queries in both SPARQL and Cypher, the Neo4j graph database has been utilized. Also, supporting this decision is that the Neo4j organization has provided examples and training around GraphRAG-specifically how to utilize the langchain library for interacting with graph databases and LLMs.

The API code is available in Appendix C and includes both the server code, referred to as the “polygraph server” codebase in section C.1 and the “polygraph client” code in section C.2. The servers run the BFT-SMaRt consensus and receive requests from the client that includes a human prompt, as well as the schema of the graph database that contains the claims data. They look up from their log files whether the prompt has been received before, and if it was and it was accurate, immediately return that query. If not, then they invoke an LLM to generate a query, and pass the schema of the knowledge graph to it for context. The LLM utilized was run on UMBC's high performance computing cluster, called Ada, as a GPU enabled environment was needed for the LLM to run. On the server the Ollama application enables downloading and running the models, and provides an API which the polygraph servers invoke if needed.

While on the front-end the user's interactions are handled via the codellama model, the server attempts to use three different models to produce a syntactically correct result: gemma, mistral, and llama2.

To enable data exploration of the claims data via an interface that integrates with the API and the BFT protocol, we installed and selected OpenWeb UI, an open source application with an interface similar to ChatGPT, that saves chat history, allows for documents to be uploaded and parsed, and provides an API connection to servers running Ollama. Two fundamental changes were made to the open source interface. First, the application was adapted to run in Electron, an open-source cross-platform framework that enables web apps like OpenWeb UI to run as a desktop application. This change was made to prove that the system's chat version can run securely within a healthcare organization's network as a deployed application if they so choose, while still being web app capable. Additionally, the Electron framework and OpenWeb UI can run on different types of devices, such as mobile phones and tablets. Second, in order to integrate the application with Medical Data Polygraph we updated the OpenWeb UI code to send the prompt to the polygraph servers as well as to the backend LLM.

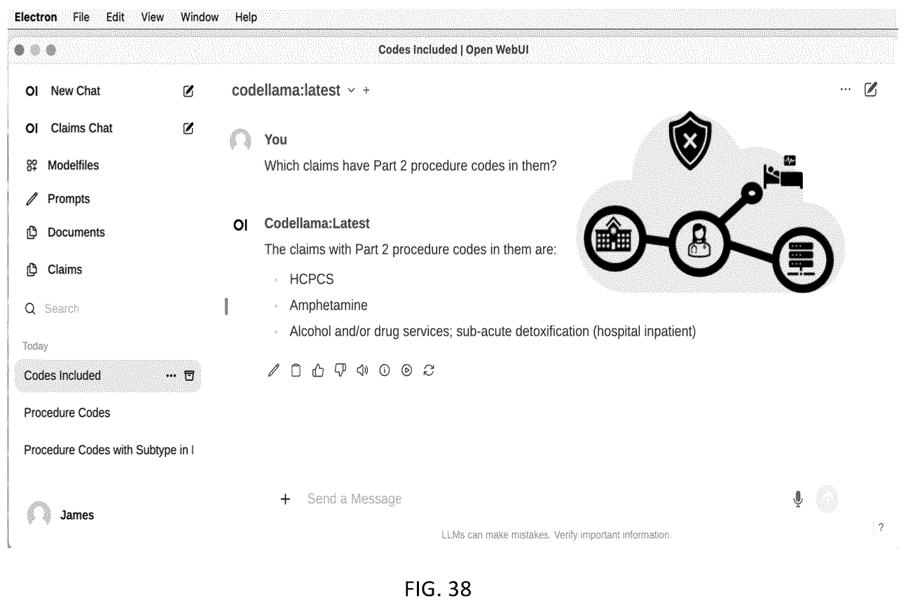

The Medical Data Polygraph chat UI provides the user the ability to select models, and in our case we chose codellama, a specialized code generation model offered by Meta. FIG. 38 illustrates a screen display that shows the system chat, with a question about which claims contain Part 2 procedure codes. In this case, the model responded by returning the information from the Part 2 graph combined with the claims the graph had loaded, which contained claims with the HCPCS code for “Alcohol and/or drug services; sub-acute detoxification (hospital inpatient).”

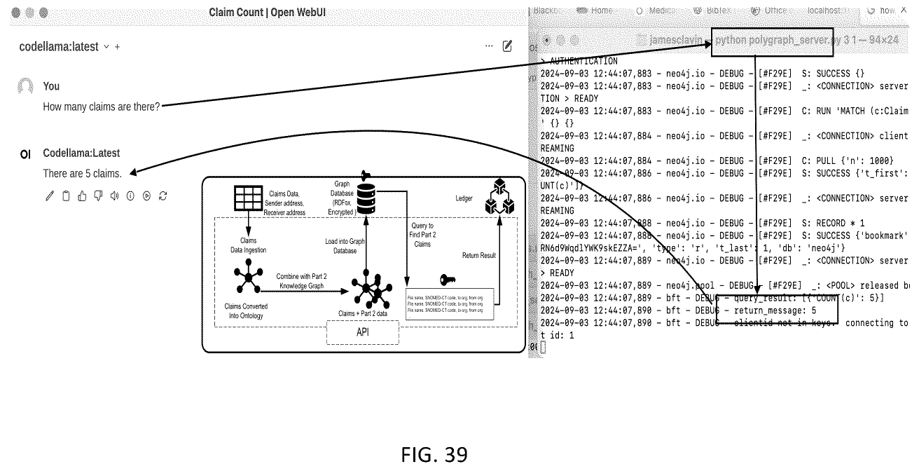

FIG. 39 illustrates a screen display showing a user interface call to the server. Referring to FIG. 39, the user has asked how many claims are in the data set on the left. The server's translation of the prompt into Cypher and its response is highlighted on the right. The response is presented back to the user in natural language.

To assess the utilization of knowledge graphs and blockchain to both detect faulty claims data and enable further exploration, our research took on two tracks. First, finding claims data was examined that contains a certain diagnosis of interest, namely Part 2 data, within it by sending claims data in batch between health care organizations set up as nodes in an Ethereum network. Second, exploration of claims data was enabled by experts who are looking for outliers in the data. The foundation of this approach was to consider what claims adjudication managers typically look for when examining faulty claims, and to consider how most claims are exchanged via EDI.

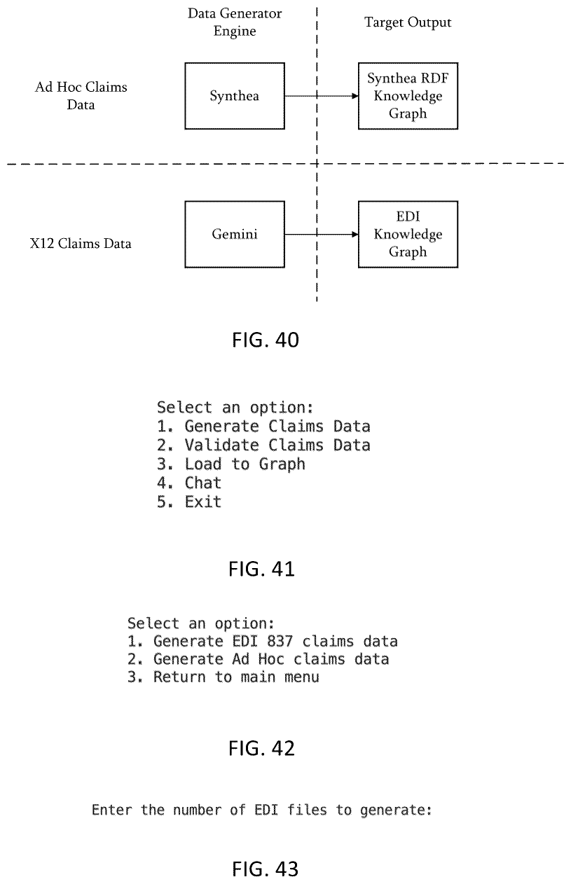

Because of the sensitive nature of claims data, a claims data generator was created to validate the approach before beginning to test with real-world claims data. To do so, an application was developed to create and validate claims data in both EDI and ad hoc data formats; the complete set of code is available in Appendix A. FIG. 40 illustrates a diagram with data generators and shows the ad hoc claims data being generated by Synthea, then loaded into a knowledge graph. Also, displayed is the ASC X12 EDI data being generated by Gemini and loaded into a graph. The application developed supported both of these uses.

FIG. 41 illustrates a user interface including the application's main screen (it is a command line based app). The user can select to create, validate, load data to knowledge graph, or chat with claims data.

Selecting ‘1. Generate Claims Data’ presents the user with the option to create either EDI 837 or Synthea ad hoc data as displayed in FIG. 42, which illustrates a user interface including data generation options.

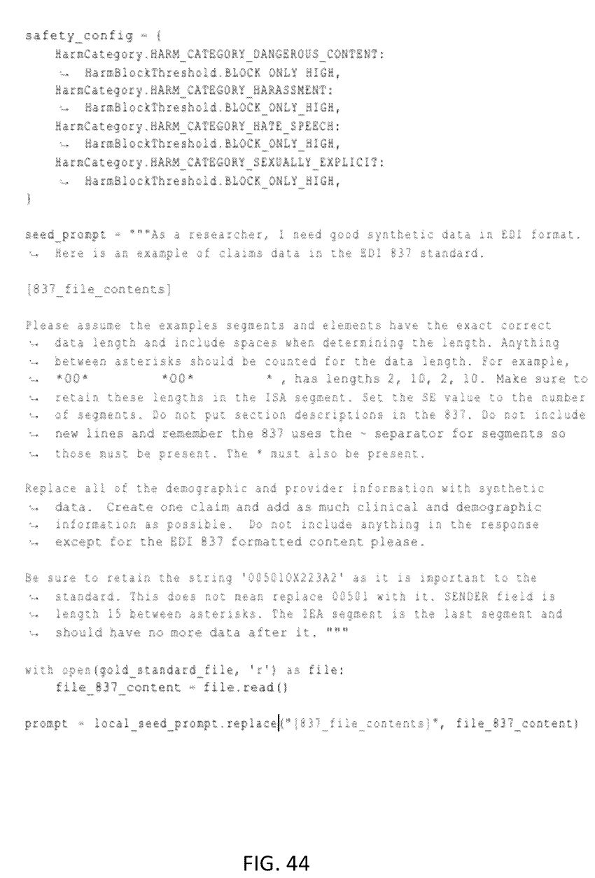

After selecting EDI data generation, the application asks the user for the number of files they would like to generate (see FIG. 43, which illustrates a user interface for EDI data generation options). An example output file of the user choosing to generate one file was provided herein, when discussing Google Gemini. The Python code to access Google Gemini uses the API provided by Google. FIG. 44 shows an excerpt of the code, demonstrating connecting to Gemini and prompting it to generate EDI data. (See section A.2 of the appendix for the complete set of code to generate EDI 837 data). The code contains a seed prompt as well as the Gemini API safety requirement configuration settings. To not be blocked by Google, the prompt required stating “As a researcher . . . ”. Additionally, the safety configuration settings were set to block at the highest level. Any harassment, hate speech, or sexually explicit content generation is permissible only at the “high” threshold; we point the reader to for the available settings. To increase the accuracy of the LLM, an example data file of syntactically accurate synthetic EDI data was provided in the context; the file is referred to as a “gold standard” file in the code. This file was provided by an EDI expert and is available in section A.7.

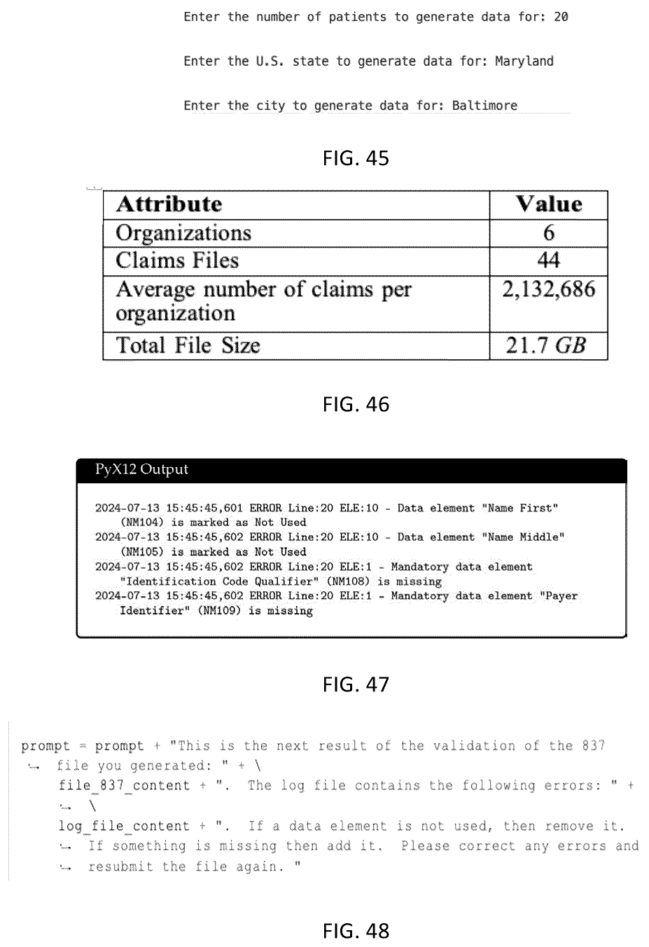

After selecting Ad Hoc data generation, the application asks the user for the number of patients they would like to generate, as well as for the state and city the patients should be from (see FIG. 45, which shows a user interface with ad hoc data generation options). Appendix section A.3 has the complete set of code to generate Ad Hoc data.

Ad hoc synthetic claims data was generated by utilizing the Synthea RDF library. This Python library acts as a wrapper to Synthea, a highly configurable patient data generator, and then converts the patient data into Terse RDF Triple Language (ttl) data files.

Patient claims data sets were produced using Synthea and then translated the data into an ontological format library. This included a set of 12M claims for 60,000 patients for six hospitals in distinct geographic locations. FIG. 46 shows a table containing example claims data. This table shows the overall file count, size and average number of claims per organization. Each patient had zero or more claims, and each claim had eight mutually exclusive diagnoses fields contained in a set of 44 files.

The data generated by the LLM is forwarded through an open source Python library to determine if the claim format contained EDI errors. In the event errors similar to those shown in FIG. 47 (illustrating example error log containing issues with data elements) occurred, the system incorporates the errors back into the context and re-runs the creation of the EDI data as shown in FIG. 48, which illustrates Python code to regenerate EDI claims data using X12 validation in context. This process can be repeated until no errors occur or a maximum number of iterations is met. In the event that the maximum number is reached, the error log is retained for usage downstream in the knowledge graph. The EDI validation code is available in Appendix section A.4.

Synthea by default produces data that confirms to its sets of rules, and therefore we did not consider adding additional data validations. It is noted that it is possible to create errors in the data if necessary.

Now that it has been shown that claims can be generated in either an industry standard or ad hoc fashion, it is considered how best to measure analyzing their contents. A strategy is described into two modes of operation: batch and real-time.

Data exchanges of claims data include voluminous amounts of information being exchanged. For measuring batch transactions we will take into account the size of data files being exchanged, the number of claims, and the number of clinical terms within the claims. The effort to identify the number of clinical terms within claims that are of interest is measured, in this case example those that contain Part 2 data, by using Ethereum gas. As our primary focus is on Part 2 data exchange compliance, all Part 2 terms were categorized as shown in FIG. 19. By having a means to measure the effort in gas expended as well as time spent, we are able to calculate the cost of Part 2 HIPAA compliance auditing of Part 2 data exchanged. As described herein, the gas price is the amount of Ethereum required to execute an on-chain contract. For batch measurement we focus on Synthea ad hoc data. A suite of benchmarking tools was developed to gather block information; these codes is available in Appendix section D.3.

In real-time, the focus is on enabling accurate and consistent data exploration of claims using a chat interface. The user should be able to find anything unusual or non-compliant within the claims data, using the lessons learned from claims administrators we contacted. As with batch, the use case of the identification of Part 2 data and how to measure it were considered. This can present a large problem domain, even though we focus on Part 2 terms. In this mode, measurement is done through assessing the prompt-to-backend-query accuracy and keeping a log of correct and incorrect queries maintained through a Byzantine Fault Tolerant protocol. The log is generated by servers running BFT-SMaRt. The servers must concur on the query generated and if they do not then the system is not secure.

If the servers return a syntactically accurate but useless query, i.e. a query that will run on the claims data but is not pertinent to the human prompt, the BFT consensus logs these as a final result that is not to be repeated. Successful queries that are returned with the right answer to the human, are logged as well, but are not considered final until the reinforcement learning from human feedback (RLHF) tells the BFT servers to make the response final. Future queries from the human that occupy a vector space close to these correct queries' original human prompts, cause the servers to respond immediately with the stored answer, and to run that on the claims data. For real-time measurement we use both Synthea ad hoc data and EDI data.

The architecture for batch processing is for data to be sent through an Elixir based API that combines the data with a knowledge graph to find Part 2 claims in it, then log those on a blockchain by recording the sender, the receiver, and the file name that contained the Part 2 data. To support this, experiments were run on a server running the Ubuntu operating system with 72 Intel® Xeon® Gold 6140 CPU@2.30 GHz CPU's.

For real-time processing we ran our experiments locally on a Macbook Pro with Apple M1 chip and 16 GB memory in combination with the UMBC High Performance Computing Facility “ada” GPU Cluster (referred to as “ada” henceforth). The Macbook was used to serve up the front-end application, a Chat-GPT like interface. On the backend, “ada” was used to host the large language model.

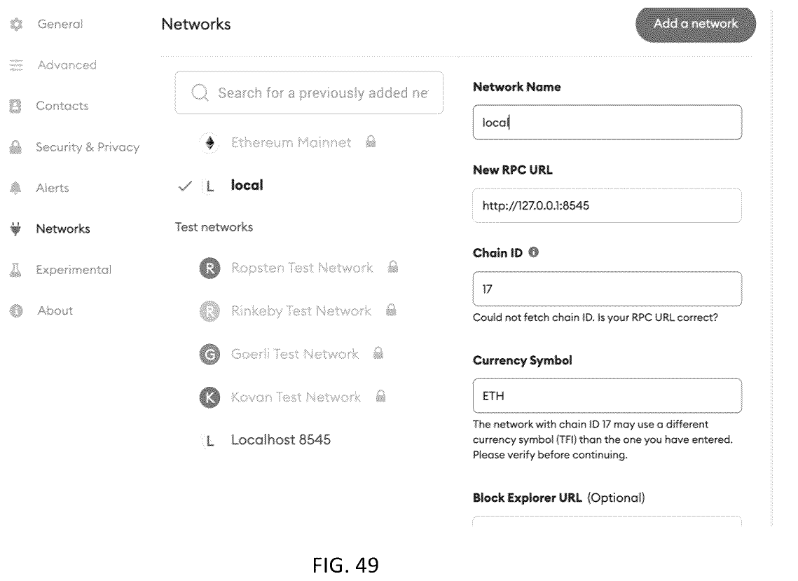

Ethereum has been used a proof of work (PoW) consensus protocol for validating transactions. Thereafter, the consensus mechanism became proof of stake. Under the pre-merge PoW Ethereum, a test network (testnet) was created on a server housed. The testnet consisted of one node running PoW consensus, with multiple accounts. To deploy smart contracts to an OpenEthereum testnet, a digital wallet with accounts that have gas was required. A common wallet for Ethereum transactions was then, and remains, an application called MetaMask, that can readily plug in to web browsers. FIG. 49 illustrates a user interface showing a MetaMask and reflects its ability to connect to MainNet, local testnets, and public test networks.

The OpenEthereum blockchain functions as an audit trail, and for measuring the cost incurred identifying compliance issues buried in claims data sets of varying size. When invoking the compliance checking smart contract, we measure the resources used in gas expended as measured in Gwei, or one-billionth of one ETH.

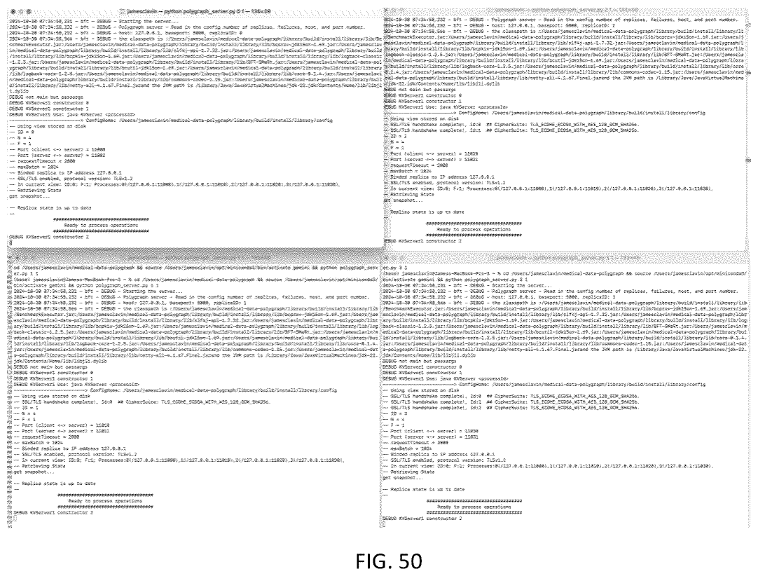

Real-time analysis focused on the consistency and accuracy of the cypher queries the polygraph servers generated and came to consensus on. To monitor performance, four polygraph servers running and observed their consensus protocol execute were instantiated. FIG. 50 shows the servers starting and preparing to take client requests.

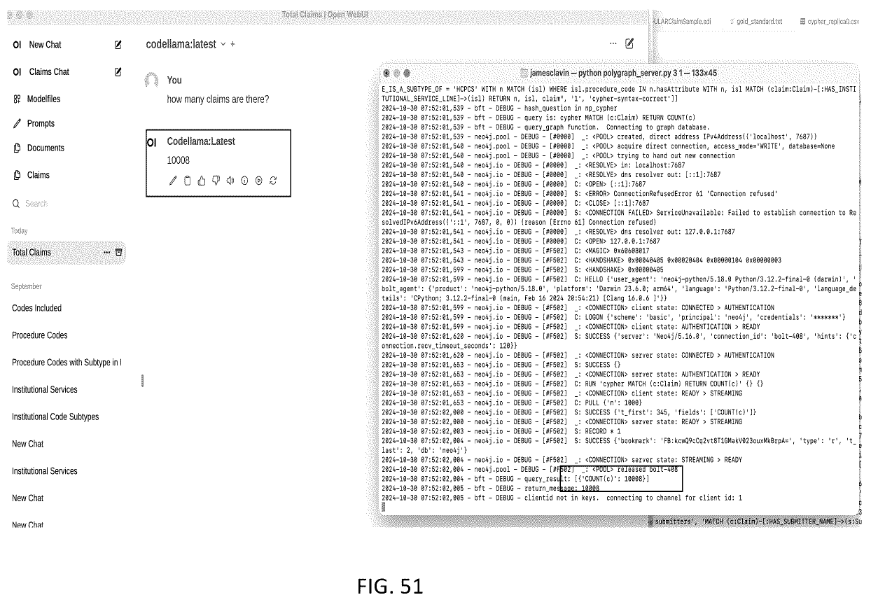

FIG. 51 shows the Electron-based application with the human prompt on the left, and the server response on the right. In the highlighted rectangles, the response to the query about the number of claims is 10,008.

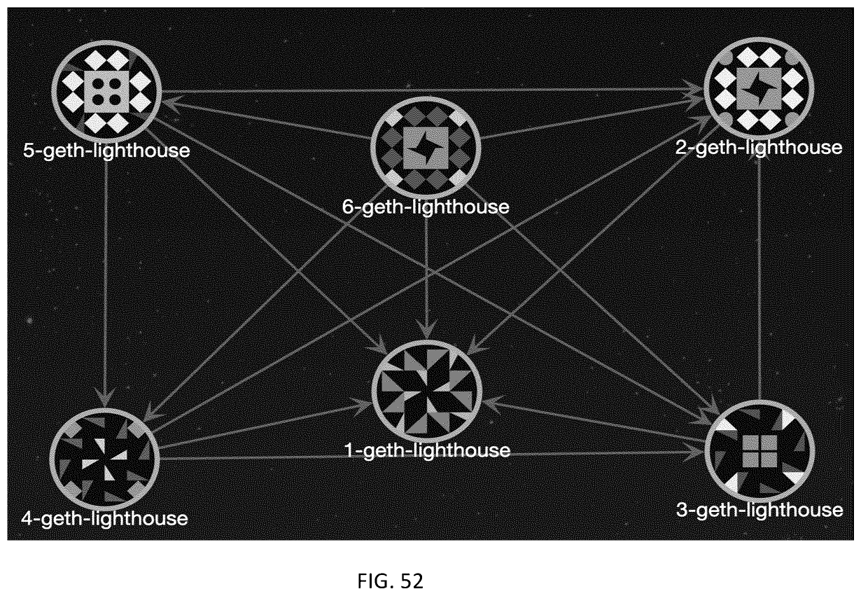

A key consideration for Batch mode using OpenEthereum was that OpenEthereum was a pre-merge solution. Ethereum switched from Proof of Work consensus to Proof of Stake, necessitating that the Medical Data Polygraph's ability to continue to work post-merge was validated. To do so, Kurtosis was installed on the server and configured the TEFCA network as a series of different types of Ethereum nodes. Kurtosis is a docker containerization solution designed to enable testnet and smart contract development by easily spinning up and down nodes within a closed network. The kurtosis solution also sets up accounts for the developer so they do not have to be funded from a faucet or imported from another testnet (as would have been the case for us to use the same accounts from our pre-merge research). This eliminated the need to use Metamask as described herein. Additionally, as seen in FIG. 52 (which illustrates Kurtosis TEFCA network layout), the nodes were configured in the Kurtosis network to closely align with the TEFCA network described herein. The diagram FIG. 52 displays a specific type of Ethereum node, in this case ‘geth’, which is the Go version of Ethereum.

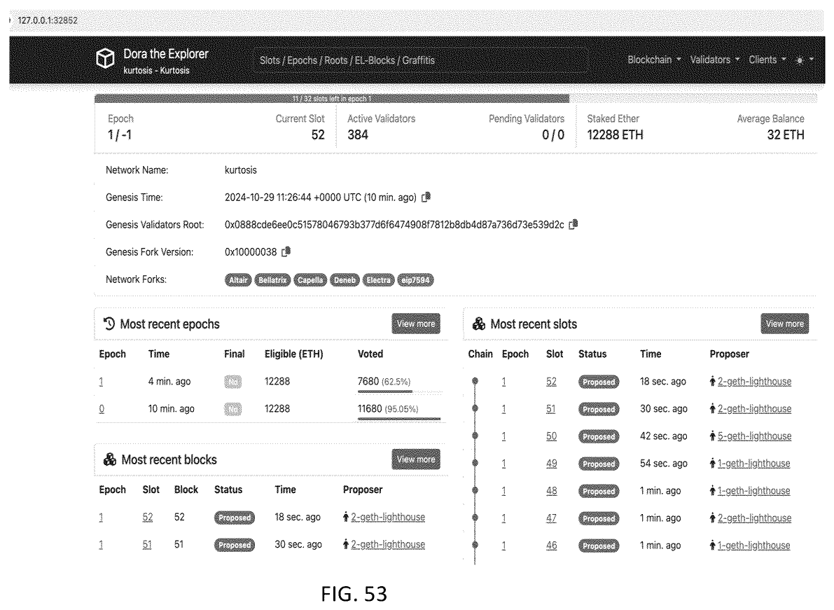

A high-level overview of the TEFCA network is also possible by configuring Kurtosis to start the Dora chain explorer. The TEFCA networks status is presented in FIG. 53, which illustrates a Kurtosis TEFCA network overview. This is a real-time view into the most recent epochs, blocks, and slots; the nodes that are proposing the work are listed, and match to the figure above.

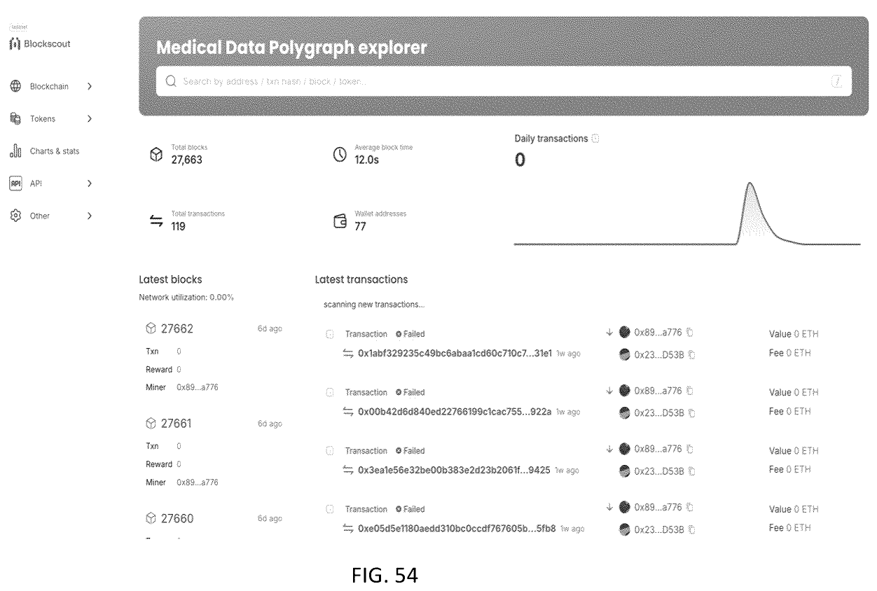

This provides a new level of insight into the costs associated with out of compliance data exchange. However, given reliance of the Medical Data Polygraph on Blockscout for examining (see sub-subsection 4.4.1.3), newer versions of Blockscout were validated to work to explore one node's transactions. A Blockscout based UI was connected to the network, and rebranded the Medical Data Polygraph to took on the new look and feel shown in FIG. 54, which illustrates a system batch mode-Blockscout post-merge.

Smart contract development capabilities also advanced significantly from our first contract development, for which remix was used (as described in sub-section 4.4.1.2). Of the new contract development tools available, Hardhat was developed for post-merge contract development, validation, and deployment. The same contract was deployed as pre-merge to this new kurtosis based testnet via Hardhat, and then attempted to connect our API to it. The Elixir API failed, and had to be updated; the updated code is available in Appendix E. A positive byproduct of the upgraded code was that it become more dynamic; it creates new functions based upon the contract function definitions directly, by using an Elixir version of the popular javascript library Ethers.

In order to support public contribution and review, portions of the Medical Data Polygraph have been carved out and made publicly available. The Part 2 Knowledge Graph is available on github as a part of the Health Information Exchange Synthetic Data Generator, and includes a set of clinical terms for substance abuse and mental health, mapped into a knowledge graph. These terms are called Part 2 data, referring to 42 Code of Federal Regulations Part 2, which is intended to safeguard this kind of sensitive health information. It also includes scripts to generate synthetic claims data. The data is output in TTL format and can then be linked to the Part 2 graph on SNOMED-CT terms.

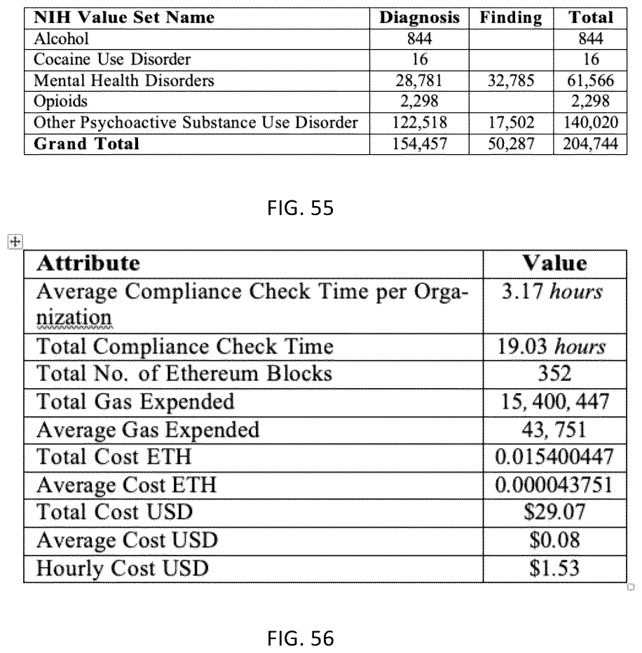

Using the SNOMED-CT terms disclosed herein, claims can be identified that require patient consent shared between six organizations for approximately 60,000 patients. The data was examined to detect one of 1,944 clinical terms in one of eight diagnosis fields for one of 44 files, giving U.S. Pat. No. 1,944,352 possibilities for one or more Part 2 clinical terms to be present in the claims. From this set of possibilities, our actual number of Part 2 terms generated totaled 204, 744. The table of FIG. 55 shows the distribution of this sample according to our knowledge graph's attributes of value set name-either diagnosis or finding in this case as we have no lab data.

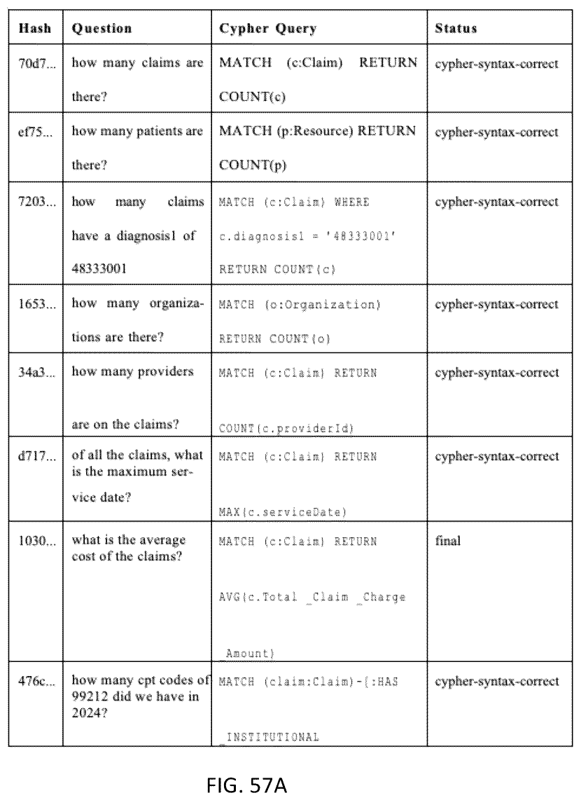

For all 44 claims files, the mode and median claim file size was 529 MB. The table shown in FIG. 56 captures the performance and cost metrics, showing that it took on average 3.17 hours to check data exchange point-to-point between all six organizations. Checking all files took 19.03 hours and produced 352 blocks of data in Ethereum. Converting the Ethereum gas expended into U.S. dollars with a then-current exchange rate, the effort expended $29.07 total, averaging $0.08 per block, at a cost of $1.53 per hour.

To measure if Part 2 data was shared in a batch transaction, a block with a single transaction listing the cause for compliance failure is added to the OpenEthereum blockchain via smart contract as described herein. The block contains a transaction that has the sender organization, the compliance smart contract address, and the gas expended by the transaction. These values as well as the raw in-put to the smart contract are presented herein, where the file name is duke_to_wake_claim_0.ttl, the diagnosis field is the first on the claim, and the SNOMED-CT codes vary across claims. The gas expended in this example is 68,577, which is 0.000068577 ETH or $0.13.

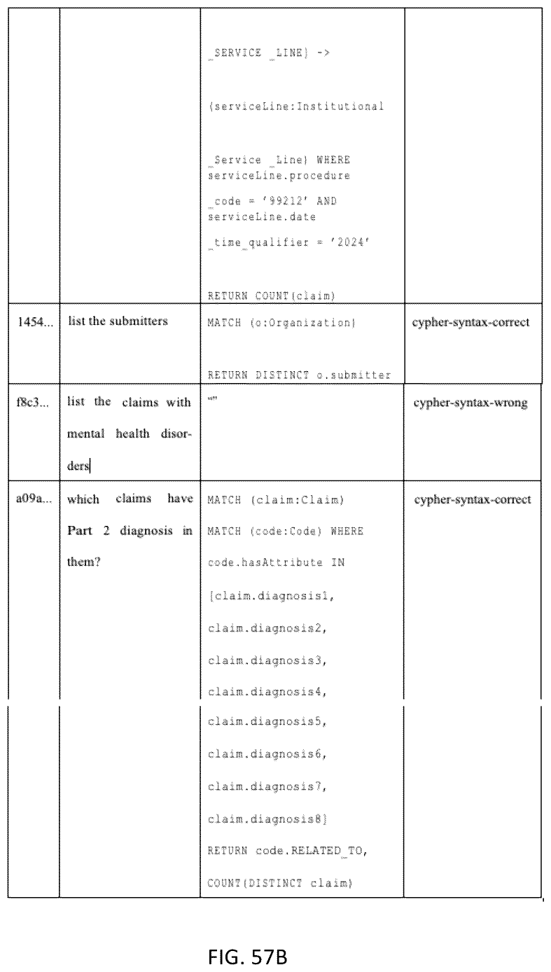

We tested a series of prompts to determine how Medical Data Polygraph would come to a consensus in its response. FIG. 57A and FIG. 57B show displays a log excerpt from one of the polygraph servers. Included is the hash of the prompt, the prompt from the human, the resulting graph query, and the query status. The status “cypher-syntax-correct” indicates that the prompt was converted into a query that when run against the graph database did not generate a syntactic error. Similarly, “cypher-syntax-wrong” indicates that the query did generate an error when run against the graph database. A status of “final” indicates that a human has reviewed the result from the query and provided feedback that the result was accurate.

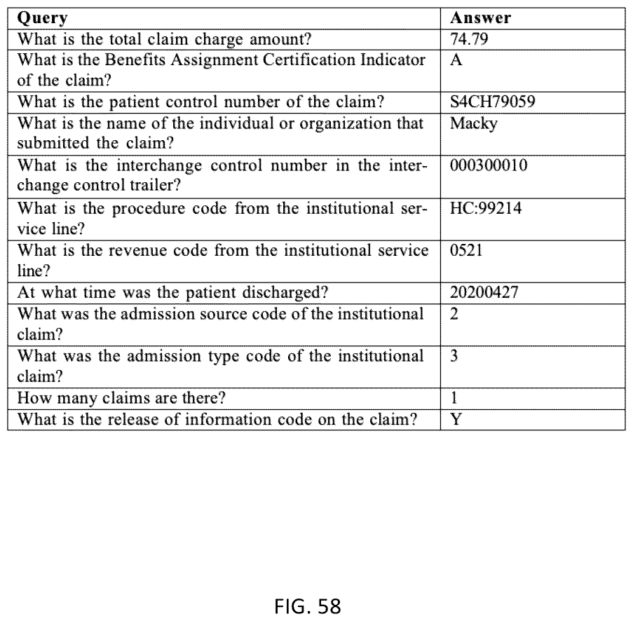

To assess the semantic accuracy of chat mode queries, we used the gold standard EDI file described hereinabove, which is available in Appendix A.7, to develop quantitative benchmarks. The benchmarks are shown in table shown in FIG. 58. The Medical Data Polygraph returned the correct result for each of these questions.

In embodiments, systems and methods disclosed herein can include a claims knowledge graph that encodes EDI 837 claims in a node-edge structure that allows queries that are not feasible or are prohibitively expensive on relational tables (e.g., joins over hierarchical loop/segment structures). This provides an improvement for data representation and query execution.

In embodiments, the regulated-content knowledge graph can be constructed and indexed in a way that enables detection of sensitive codes (Part 2, mental health, SUD) with reduced query complexity (e.g., fewer joins, bounded traversal depth, pre-materialized value-set nodes, or specific indexing schemes). This provides an improvement for data representation and query execution.

Representations such as “claim node linked to loop/segment nodes” and “diagnosis/procedure code nodes linked to SNOMED-CT or other ontologies” can yield measurable improvements (e.g., latency, memory footprint, number of I/O operations) over conventional SQL or flat file approaches when executing compliance queries across large multi-institutional datasets. This provides an improvement for data representation and query execution.

The presently disclosed subject matter can provide technical improvements to consensus techniques and reliability. Systems and methods disclosed herein can assist with avoiding failure scenarios (e.g., one node returns syntactically valid but semantically incorrect Cypher; one node fails or is compromised). These systems, such as those including BFT consensus, can detect and exclude those nodes, thereby maintaining a correct consensus natural-language response. Message patterns (e.g., pre-prepare/prepare/commit phases) and data structures (e.g., hashes of queries and result sets) exchanged among nodes can reduce the risk of replay or equivocation attacks on claims analytics.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols.

The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A system comprising:
a knowledge graph store configured to store a claims knowledge graph having nodes that represent healthcare claims, and configured to store a regulated-content knowledge graph having nodes that represent healthcare codes, wherein the nodes that represent healthcare claims in the claims knowledge graph are linked to nodes that represent healthcare codes of the sensitivity knowledge graph;
computing device nodes configured to implement a consensus protocol among each other, each computing device node comprising a graph query and response manager configured to receive a natural language input, generate a graph query based on the natural language input, and execute the graph query against the claims knowledge graph and the sensitivity knowledge graph for generating a proposed natural language response that describes one or more healthcare claims;
a consensus module configured to:
receive the proposed natural language responses from two or more of the computing device nodes; and
apply a consensus protocol to the received, proposed natural language responses to generate a consensus natural language response among the two or more of the computing device nodes; and
a user interface configured to receive the natural language input from a user, and configured to present the consensus response.

2. The system of claim 1, further comprising a large language model configured to transform the natural language input into the graph query based on a schema of the claims knowledge graph and the regulated-content knowledge graph.

3. The system of claim 1, wherein the consensus protocol is a Byzantine Fault Tolerant consensus protocol.

4. The system of claim 1, wherein the healthcare codes are associated with sensitive content.

5. The system of claim 1, wherein the healthcare codes are subject to confidentiality restrictions and/or data-use restrictions.

6. The system of claim 1, wherein each computing device node is configured to use a graph schema technique to generate the graph query.

7. The system of claim 1, wherein the healthcare codes are clinical codes.

8. The system of claim 1, wherein the regulated-content knowledge graph is constructed from value sets provided by a governmental body that designate clinical codes associated with substance abuse disorder or mental health treatment.

9. The system of claim 1, wherein the graph query and response manager is configured to provide a schema of the claims knowledge graph and the regulated-content knowledge graph as context to a large language model when generating the graph query.

10. The system of claim 9, wherein the graph query and response manager is configured to validate syntax of the generated graph query prior to executing the graph query against the claims knowledge graph and the regulated-content knowledge graph.

11. The system of claim 1, wherein the consensus module is configured to select, as the consensus natural language response, a proposed natural language response that is agreed upon by at least a quorum of the computing device nodes in accordance with the consensus protocol.

12. The system of claim 1, further comprising a blockchain interface configured to submit, to a blockchain network, a transaction comprising metadata describing:
a set of healthcare claims identified by the graph query as including healthcare codes represented in the regulated-content knowledge graph; and
a measure of computational resources expended in executing the graph query.

13. The system of claim 1, wherein the user interface is configured to present, together with the consensus response, at least one of:
an identifier of each healthcare claim referenced in the consensus response, and/or
a visualization of relationships between the healthcare claims and corresponding clinical codes in the regulated-content knowledge graph.

14. The system of claim 1, wherein the user interface is configured to:
receive user-selection of a healthcare claim referenced in the consensus response; and
present underlying claim attributes retrieved from the claims knowledge graph in response to the received user-selection.

15. The system of claim 1, wherein the claims knowledge graph and the regulated-content knowledge graph are each organized according to a graph-based retrieval-augmented generation (RAG) technique.

16. A method comprising:
storing a claims knowledge graph having nodes that represent healthcare claims;
storing a regulated-content knowledge graph having nodes that represent healthcare codes, wherein the nodes that represent healthcare claims in the claims knowledge graph are linked to nodes that represent healthcare codes of the sensitivity knowledge graph;
implementing a consensus protocol among computing device nodes, each computing device node comprising a graph query and response manager configured to receive a natural language input, generate a graph query based on the natural language input, and execute the graph query against the claims knowledge graph and the sensitivity knowledge graph for generating a proposed natural language response that describes one or more healthcare claims;
receiving the proposed natural language responses from two or more of the computing device nodes; and
applying a consensus protocol to the received, proposed natural language responses to generate a consensus natural language response among the two or more of the computing device nodes;
receiving, at a user interface, the natural language input from a user; and
presenting, via the user interface, the consensus response.

17. The method of claim 15, further comprising using a large language model to transform the natural language input into the graph query based on a schema of the claims knowledge graph and the regulated-content knowledge graph.

18. The method of claim 15, wherein the consensus protocol is a Byzantine Fault Tolerant consensus protocol.

19. The method of claim 15, wherein the healthcare codes are associated with sensitive content.

20. The method of claim 15, wherein the healthcare codes are subject to confidentiality restrictions and/or data-use restrictions.

21. The method of claim 15, wherein each computing device node is configured to use a graph schema technique to generate the graph query.

22. The method of claim 15, wherein the healthcare codes are clinical codes.

23. The method of claim 15, further comprising constructing a regulated-content knowledge graph from value sets provided by a governmental body that designate clinical codes associated with substance abuse disorder or mental health treatment.

24. The method of claim 15, further comprising providing a schema of a claims knowledge graph and a regulated-content knowledge graph as context to a large language model when generating the graph query.

25. The method of claim 24, further comprising validating syntax of the generated graph query prior to executing the graph query against the claims knowledge graph and the regulated-content knowledge graph.

26. The method of claim 15, further comprising selecting, as the consensus natural language response, a proposed natural language response that is agreed upon by at least a quorum of the computing device nodes in accordance with the consensus protocol.

27. The method of claim 15, further comprising submitting, to a blockchain network, a transaction comprising metadata describing:
a set of healthcare claims identified by the graph query as including healthcare codes represented in the regulated-content knowledge graph; and
a measure of computational resources expended in executing the graph query.

28. The method of claim 15, further comprising using the user interface to present, together with the consensus response, at least one of:
an identifier of each healthcare claim referenced in the consensus response, and/or
a visualization of relationships between the healthcare claims and corresponding clinical codes in the regulated-content knowledge graph.

29. The method of claim 15, further comprising using the user interface to:
receive user-selection of a healthcare claim referenced in the consensus response; and
present underlying claim attributes retrieved from the claims knowledge graph in response to the received user-selection.

30. The method of claim 15, further comprising providing claims knowledge graph and the regulated-content knowledge graph that are each organized according to a graph-based retrieval-augmented generation (RAG) technique.
